(19) United States
(12) Patent Application Publication
(10) Pub. No.: US 2014/0365350 A1
(43) Pub. Date: Dec. 11, 2014

(54) FINANCIAL PLATFORM THAT FACILITATES MANAGEMENT OF FINANCIAL SERVICES

(71) Applicant: Rawllin International Inc., Tortola (VG)

(72) Inventor: Simon Shvarts, San Jose, CA (US)

(21) Appl. No.: 13/914,034

(22) Filed: Jun. 10, 2013

(51) Int. Cl. G06Q 40/00

(52) U.S. Cl. CPC G06Q 40/00
USPC 705/35

(57) ABSTRACT

Techniques for providing a financial services platform that can facilitate providing financial services to communication devices associated with users are presented. The financial services platform provides an interface that can incorporate base financial services and can allow a communication device user to turn on or off various add-on financial service functions. Financial service providers or third-party developers can develop, and provide to communication devices of users, financial services via a unified, standardized system provided by the financial services platform, and can create financial services by combining financial service modules associated with the financial services platform. The financial services platform provides financial services for identity management by communication devices users, credit exchange services to make pre-approved financial offers to users, and electronically signing of financial documents to create legally binding contracts with regard to pre-approved financial offers.

### TECHNICAL FIELD

This disclosure relates generally to financial-related management, e.g., to a financial platform that can facilitate management of financial services in a communication network environment.

### BACKGROUND

Today, users (e.g., consumers) can use communication devices (e.g., computers, mobile phones, electronic tablets, etc.) to access many different types of information, including financial information, perform financial transactions, and/or perform a variety of other functions. For example, users can access their bank accounts or credit accounts online, can make payments to financial accounts or transfer money between financial accounts online, or can access or receive offers (e.g., product or service sale offers) for products or services via online sites, emails, or text messages, etc.

Typically, a financial service provider, such as a bank, can provide an online financial service via a web-based application that can be accessed on the web site of the financial service provider or an application (e.g., mobile device application) that can enable a communication device to access the online financial service. Some of the financial services that a bank may provide via its online financial service can include, for example, managing a bank or credit account, making payments on a credit account, transferring money between accounts, reviewing financial transactions associated with an account, applying for a loan or line of credit. Some financial service providers also can provide online financial services that can allow a communication device user to use the communication device to request information regarding loans or loan rates offered by a number of financial service providers.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

The disclosed subject matter can include a system that can comprise a memory to store computer-executable components; and a processor, coupled to the memory, that executes or facilitates execution of at least one of the computer-executable components, the computer-executable components. The computer-executable components comprising a financial services component that facilitates generation of a set of online financial services that comprises a first online financial service associated with a first service identity and a second online financial service associated with a second service identity. The computer-executable components also comprising a financial services management component that facilitates controlling use of the set of online financial services by communication devices associated with consumer identities of a set of consumer identities.

The disclosed subject matter also can include a method comprising facilitating, by a system comprising a processor, generation of a set of online financial services that comprises a first online financial service associated with a first service identity and a second online financial service associated with a second service identity. The method also can comprise controlling, by the system, use of the set of online financial services by communication devices associated with consumer identities of a set of consumer identities.

The disclosed subject matter further can comprise a tangible computer-readable medium storing computer-executable instructions that, in response to execution, cause a system comprising a processor to perform operations, comprising: facilitating generation of a set of online financial services that comprises a first online financial service associated with a first service identity and a second online financial service associated with a second service identity; and controlling use of the set of online financial services by communication devices associated with consumer identities of a set of consumer identities.

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can employ a financial services platform to facilitate providing financial services to users via communication devices, in accordance with various aspects and embodiments described herein.

FIG. 2 depicts a block diagram of an example financial services component, in accordance with various aspects and embodiments of the disclosed subject matter.

FIG. 3 illustrates a block diagram of an example user financial services component (UFSC), in accordance with various aspects and embodiments of the disclosed subject matter.

FIG. 4 presents a block diagram of an example credit management component, in accordance with various aspects and embodiments of the disclosed subject matter.

FIG. 5 illustrates a block diagram of an example financial service provider (FSP) credit management component, in accordance with various aspects and embodiments of the disclosed subject matter.

FIG. 6 depicts a block diagram of an example consumer finances management component, in accordance with various aspects and embodiments of the disclosed subject matter.

FIG. 7 illustrates a diagram of an example system that can employ a financial services platform to facilitate providing financial services to users via communication devices, in accordance with various aspects and embodiments described herein.

FIG. 8 depicts a flow chart of an example method that can facilitate generating a new online financial service, in accordance with various aspects and embodiments.

FIG. 9 presents a flow chart of an example method for determining a desirable combination of financial service modules and/or online financial services to facilitate generating a new online financial service, in accordance with various aspects and embodiments of the disclosed subject matter.

FIG. 10 illustrates a flow chart of an example method that can facilitate approving a first entity to combine a financial service module with a financial service module associated with a second entity to generate a new online financial service, in accordance with various aspects and embodiments.

FIG. 11 depicts a flow chart of an example method that can facilitate identifying entities that can be recommended to be accepted entities (e.g., trusted entities) with regard to each other with respect to developing or selling online financial services, in accordance with various aspects and embodiments of the disclosed subject matter.

FIG. 12 illustrates a flow chart of an example method that can facilitate generating a recommendation(s) for a combination of financial service modules and online financial services (e.g., to form a customized online financial service) for a user, in accordance with various aspects and embodiments of the disclosed subject matter.

FIG. 13 is a diagram of an example wireless communication device in accordance with various aspects and embodiments of the disclosed subject matter.

FIG. 14 is a schematic block diagram illustrating a suitable operating environment.

FIG. 15 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Today, consumers can use communication devices to access many different types of information, including financial information, perform financial transactions, and/or perform a variety of other functions. When making purchases of products or services, consumers often can rely on credit (e.g., monetary loans, credit line on a credit card or other financial account, etc.) in addition to or as an alternative to using money.

Typically, a financial service provider, such as a bank, can provide an online financial service via a web-based application that can be accessed on the web site of the financial service provider or an application (e.g., mobile device application) that can enable a communication device to access the online financial service. Some of the financial services that a bank may provide via its online financial service can include, for example, managing a bank or credit account, making payments on a credit account, transferring money between accounts, reviewing financial transactions associated with an account, applying for a loan or line of credit. Some financial service providers also can provide online financial services that can allow a communication device user to use the communication device to request information regarding loans or loan rates offered by a number of financial service providers.

One type of financial services of the various types of financial services that can be provided by a financial service provider is credit services. Conventionally, in many instances, when a consumer desires credit for use in purchasing a product (e.g., car, house, appliance, home-related product, etc.) or service (e.g., obtaining a line of credit or monetary loan, heating and air conditioning service, roofing service, etc.), a consumer can fill out a loan or credit application that can include the consumer's personal information (e.g., name, address, phone number, etc.), employment history, financial or credit history, a credit check authorization, and/or other information. The potential creditor can review the information provided by the consumer and/or can access the person's financial or credit history through a third-party service (e.g., a financial or credit history aggregator service, which also can provide a standardized credit score that can be indicative of the credit worthiness of the consumer). Based at least in part on the review of the information provided by the consumer and/or the person's financial or credit history obtained via a third-party service, the potential creditor can make a determination regarding whether to offer the desired credit to the consumer for the purchase of the product. If the potential creditor determines that the consumer is sufficiently creditworthy, the potential creditor may make an offer to extend credit to the consumer in relation to the purchase of the product.

Conventional processes for obtaining credit can be inefficient. For example, conventional processes for obtaining credit can be unnecessarily time consuming, as consumers may have to fill out a credit application and submit the application for approval before potentially receiving an approved financial offer or learning that they have not been approved for credit. Conventional processes for obtaining credit also can reduce the use of credit from a financial services provider by creditworthy consumers, as creditworthy consumers may not realize some credit opportunities available to them or may use other available financial resources (e.g., money from bank account, credit card from another financial services provider, etc.) to facilitate making purchases of products or services instead of using the financial services provider. Another deficiency can be that conventional processes for obtaining credit may reduce the purchase of products and services by creditworthy consumers, as creditworthy consumers may not realize some credit opportunities available to them to facilitate making purchases of products or services and, as a result, may not purchase such products or services thereby resulting in a reduction in product or service purchases.

To that end, techniques for providing a financial services platform that can facilitate providing financial services to communication devices associated with users are presented. The financial services platform can provide an interface that can incorporate base (e.g., core) online financial services (e.g., deposit money into a bank account, transfer money from one account to another account, schedule payment on a billing account) and can further allow a communication device user to turn on or turn off various add-on online financial service functions and use desired add-on online financial service functions. The financial services platform can generate a unified, standardized system that can be provided to financial service providers, third-party service developers, and consumers to facilitate the creation and use of online financial services, which can be provided to communication devices (e.g., communication device of a consumer, communication device of a financial service provider) associated with the financial services platform.

The financial services platform can comprise a financial services component that can perform a variety of functions that can facilitate creating online financial services and providing online financial services to consumers associated with the financial services platform via their communication devices. The financial services component can include an application programming interface (API) component that can make APIs, API tools, or other components or functions available to communication devices associated with financial service providers, third-party service developers, and consumers to use in developing online financial services that can be used via the financial services platform. The API component can comprise financial service modules (e.g., financial service sub-components) that can have respective financial service functions. The API component also can facilitate enabling financial service providers, third-party service developers, and consumers to use their respective communication devices to access the API component to generate new financial service modules, which can have respective financial service functions, and the new financial service modules can be stored by the API component. A new financial service module can be used by the entity that developed the new financial service module or by another entity (e.g., to facilitate creating a new online financial service comprising the new financial service module and one or more other financial service modules associated with the financial services platform. For instance, a financial service provider, third-party service developer, or consumer can use a respective communication device to access the financial service modules, and the API tools or functions, associated with the API component, and can combine desired financial service modules to facilitate creating an online financial service that can have a set of functions based at least in part on the respective functions of the combined financial service modules.

The financial services platform can facilitate providing a variety of online financial services, including online financial services associated with an open credit exchange platform, to consumers. Some of the online financial services (e.g., credit exchange services) that can be provided to consumers (e.g., using their communication devices) via the open credit exchange platform can include, for example, an online financial service that can facilitate identity management by consumers, an online financial service that can facilitate making pre-approved financial offers to consumers, an online financial service that can facilitate determining a preferred (e.g., best) pre-approved financial offer from a set of pre-approved financial offers made to a consumer by financial service providers, and an online financial service that can facilitate electronically signing of electronic financial documents to create legally binding contracts with regard to pre-approved financial offers, among other online financial services, such as those disclosed herein. In some implementations, some or all of these respective credit exchange services can be incorporated in respective financial service modules, wherein these financial service modules also can be utilized by financial service providers, third-party service developers, or consumers to facilitate creating other online financial services by combining some of these financial service modules with other financial service modules (e.g., via accessing the API component using their respective communication devices).

In some implementations, the financial services component also can comprise a financial services store component that can generate, maintain, and/or update a database(s) of online financial services (e.g., financial service applications) and/or financial service modules. The financial services store component can generate an online store that can be accessed by communication devices associated with financial service providers, third-party service developers, or consumers to facilitate enabling financial service providers, third-party service developers, or consumers to access, download, and/or purchase online financial services or financial service modules. Depending in part on the online financial service or financial service module, the online financial service or financial service module can have a cost (e.g., financial cost or other cost) associated with it or it can be available at no cost. The financial services component also can comprise a search engine that can be used to facilitate searching for online financial services or financial service modules maintained by the database(s). A communication device associated with a financial service provider, third-party service developer, or consumer can be used to generate a search query comprising a search term, a search phrase, search category, etc., that can be provided to the search engine. The search engine can search the database(s) to determine one or more online financial services or financial service modules that can be responsive to the search query. The search engine can facilitate providing a set of search results that can provide information relating to the one or more online financial services or financial service modules determined to be responsive to the search query. The entity associated with the communication device can use the communication device to select a search result(s) in the set of search results to facilitate accessing or obtaining an online financial service(s) or financial service module(s) associated with the selected search result(s).

In other implementations, the financial services component also can facilitate locating new entities (e.g., financial service partners, such as financial service providers, third-party service developers, etc.), validating new entities, classifying new entities, and/or associating new entities with the financial services platform.

These aspects and other aspects of the disclosed subject matter are further described in relation to the drawings.

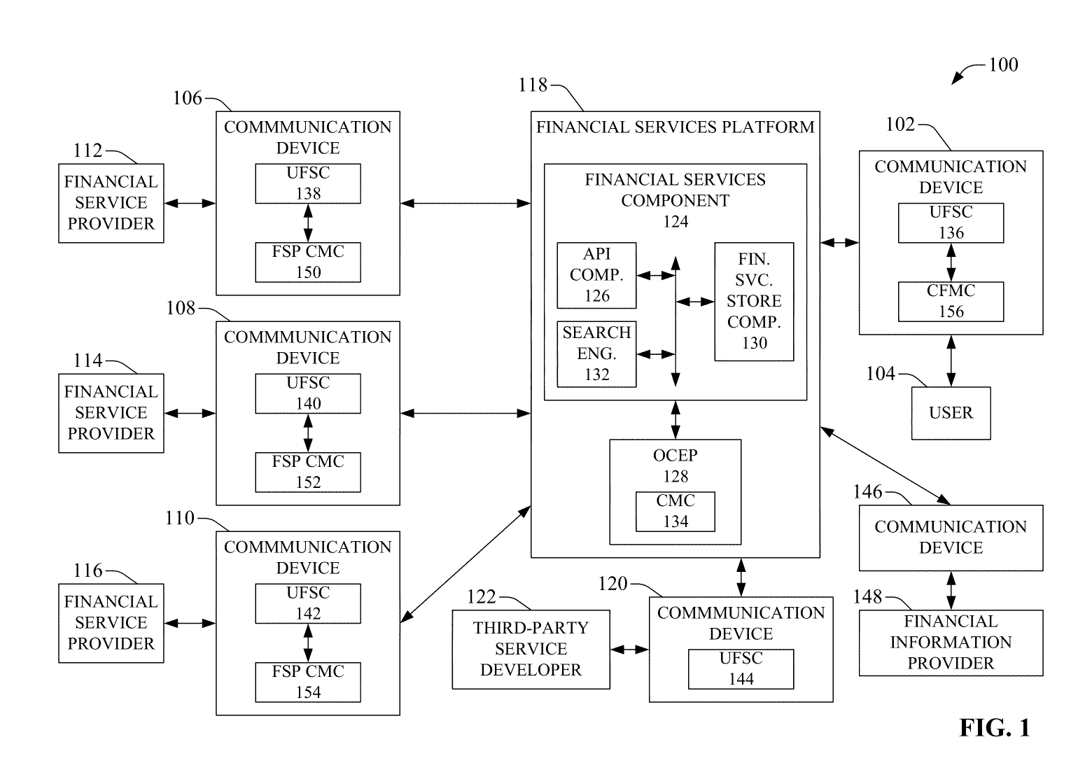

FIG. 1 illustrates a block diagram of an example system 100 that can employ a financial services platform to facilitate providing financial services to users via communication devices, in accordance with various aspects and embodiments described herein. In an aspect, the system 100 can include a communication device 102 that can be associated with a user 104 (e.g., consumer). The communication device 102 can be, for example, a computer, a mobile or wireless communication device (e.g., a mobile phone and/or smart phone), an electronic tablet, pad, or notebook, an electronic gaming device, a set-top box, a personal digital assistant (PDA), or other electronic device having communication functionality.

The system 100 also can include a plurality of other communication devices, including communication device 106, communication device 108, and communication device 110, that can be respectively associated with a plurality of financial service providers, including financial service provider 112, financial service provider 114, and financial service provider 116. The financial service providers (e.g., 112, 114, 116) can be banks, lenders, stores, product or service providers that also provide financial services, peers (e.g., for peer-to-peer approved financial offers from one user (e.g., peer) to another user (e.g. peer)), or other entities. The financial service providers (e.g., 112, 114, 116) can be, for example, brick-and-mortar entities, or online or virtual entities. As part of their business, the financial service providers (e.g., 112, 114, 116) can lend money to users, maintain financial accounts (e.g., bank account, credit account, etc.) for users, extend credit (e.g., via a credit card account, credit line, etc.) to users, etc. In some instances, the financial service providers (e.g., 112, 114, 116) can provide the financial services (e.g., money loan, extension of credit, etc.) in relation to the purchase of products or services from the financial service provider or a third-party product or service provider.

The system 100 also can include a financial services platform 118 that can facilitate maintaining online financial services (e.g., core online banking services and/or various add-on online financial services), providing online financial services to users (e.g., consumers, financial service providers, etc.), maintaining and/or providing (e.g., to users) financial service modules (e.g., financial service sub-components) that can be used to facilitate developing new online financial services, providing APIs and related tools or components (e.g., API sub-components) that can be used to facilitate developing online financial services, etc. The financial services platform 118 can be associated with (e.g., communicatively connected to) various communication devices, including communication devices 102, 106, 108, 110, 120, and 146 (e.g., via a communication network).

With regard to consumers (e.g., user 104), the financial services platform 118 can provide a single, unified, and/or standardized interface(s) and other components that can incorporate and provide base (e.g., core) online financial services (e.g., deposit money into a bank account, transfer money from one account to another account, schedule payment on a billing account) and can further allow a consumer to use a communication device (e.g., 102) to facilitate turning on or turning off various add-on online financial services (e.g., turning on or turning off functions of add-on online financial services) and using desired add-on online financial services, as provided by and/or via the financial services platform 118. The financial services platform 118 can generate and/or provide unified, standardized interfaces, financial service modules, and/or other functions or tools that can be available to financial service providers (e.g., 112, 114, 116), third-party service developers (e.g., 122), and consumers (e.g., user 104) to facilitate the creation and use of online financial services, via their respective communication devices (e.g., communication device 102 associated with a consumer, communication device (e.g., 106, 108, 110)) associated with a financial service provider (e.g., 112, 114, 116), communication device 120 associated with a third-party service developer 122) associated with the financial services platform 118. The financial services platform 118 can be an always-on, always-updating platform that can facilitate updating information associated with the financial services platform 118 in real or near real time.

The financial services platform 118 can comprise a financial services component 124 that can perform a variety of functions that can facilitate creating online financial services and providing online financial services to users (e.g., user 104, financial service providers (e.g., 112, 114, 116), third-party service developers (e.g., 122)) associated with the financial services platform 118 via their communication devices (e.g., 102, 106, 108, 110, 120, etc.). The financial services component 124 can include an API component 126 (API Comp. 126) that can make APIs and API sub-components (e.g., API tools, processes, functions, etc.) available to communication devices (e.g., 102, 106, 108, 110, 120, etc.) associated with financial service providers (e.g., 112, 114, 116), third-party service developers (e.g., 122), and consumers (e.g., user 104) to use in developing online financial services that can be used via the financial services platform 118. For instance, the API sub-components can comprise a set of API sub-components that can include routines, data structures, object classes, data variables, functions, interfaces, etc., that can be used, in accordance with a defined API protocol(s), to facilitate generating online financial services to perform financial-service-related functions or operations on data (e.g., financial-related data associated with consumers). The API component 126 can comprise or facilitate development of financial service modules that can have respective financial service sub-components that can perform respective functions or operations on data. The API component 126 also can facilitate enabling financial service providers (e.g., 112, 114, 116), third-party service developers (e.g., 122), and consumers (e.g., user 104) to use their respective communication devices (e.g., 102, 106, 108, 110, 120, etc.) to access the API component 126 to generate new financial service modules (e.g., by using the API sub-components), wherein the new financial service modules can have respective financial service functions that can perform respective financial-service operations on data (e.g., financial-related data associated with a consumer), and the new financial service modules can be stored by the API component 126 (e.g., in a data store).

A new financial service module can be used by the entity (e.g., third-party service developer (e.g., 122)) that developed the new financial service module or by another entity (e.g., a financial service provider (e.g., 112)) to facilitate creating a new online financial service comprising the new financial service module and one or more other financial service modules associated with the financial services platform 118. For instance, a financial service provider (e.g., 112), third-party service developer (e.g., 122), or consumer (e.g., user 104) can use a respective communication device (e.g., 106, 120, 102) to access the financial service modules, and the API sub-components or tools, associated with the API component 126, and can combine desired financial service modules to facilitate creating an online financial service that can have a set of functions based at least in part on the respective functions of the combined financial service modules. The API component 126 can store that online financial service, wherein such online financial service can be available for use by, for example a consumer (e.g., user 104) via a communication device (e.g., 102).

The financial services component 124 (e.g., using the API component 126) can facilitate generating a variety of online financial services and financial service modules. Some examples of the online financial services or financial service modules that can be generated by, and/or generated as facilitated by, the financial services component 124 can include an identity-management service that can facilitate enabling a user to control what information (e.g., financial-related information, personal information, etc.) associated with the user is exposed to other entities (e.g., financial service providers, financial information providers, etc.) and/or control identification information (e.g., name or other identifying information) associated with the user, an electronic-signature service that can facilitate the digital signing of electronic documents (e.g., electronic contract documents) and verification of the digital signature, a financial-score service that can facilitate determining and updating financial scores associated with users, an offer-identification service that can facilitate determining or identifying a preferred approved (e.g., pre-approved) financial offer to be presented to a user, an information-standardization service that can facilitate standardizing or synthesizing information (e.g., financial-service information) associated with users to generate a set (e.g., a defined number) of financial-related parameters for use by financial service providers in making decisions regarding approved financial offers for users, an approved-offer service that can facilitate enabling financial service providers to make approved financial offers to consumers, and/or other online financial services or financial service modules (e.g., services or modules that can facilitate performance of functions or operations associated with the financial services platform 118 or open credit exchange platform 128), such as more fully disclosed herein (e.g. with regard to the financial services platform 118 and open credit exchange platform 128).

The financial services platform 118 can comprise the open credit exchange platform 128 (OCEP 128), and the financial services platform 118 can facilitate providing a variety of online financial services, including online financial services associated with the open credit exchange platform 128, to consumers (e.g., user 104), financial service providers (e.g., 112, 114, 116), and/or other users via their communication devices (e.g., 102, 106, 108, 110, etc.). Some of the online financial services (e.g., credit exchange services) that can be provided to consumers (e.g., using their communication devices) via the open credit exchange platform 128 can include, for example, an online financial service (e.g., identity-management service) that can facilitate identity management by consumers, an online financial service (e.g., an approved-offer service) that can facilitate enabling financial service providers to make approved (e.g., pre-approved, unconditionally approved) financial offers to consumers, an online financial service (e.g., an offer-identification service) that can facilitate determining a preferred (e.g., best) approved financial offer from a set of approved financial offers made to a consumer by financial service providers, and an online financial service (e.g., an electronic-signature service) that can facilitate electronically signing of electronic financial documents to create legally binding contracts with regard to pre-approved financial offers, among other online financial services, such as those disclosed herein. In some implementations, the financial services component 124 can incorporate some or all of these respective credit exchange services in respective financial service modules, wherein these financial service modules also can be utilized by financial service providers (e.g., 112, 114, 116), third-party service developers (e.g., 122), or consumers (e.g., user 104), using their respective communication devices (e.g., 102, 106, 108, 110, 120, etc.), to facilitate creating other online financial services by combining some of these financial service modules with other financial service modules (e.g., via accessing the API component 126 using their respective communication devices).

In some implementations, the financial services component 124 also can comprise a financial services store component 130 (Fin. Svc. Store Comp. 130) that can generate, maintain, and/or update a database(s) of online financial services (e.g., financial service applications) and/or financial service modules. The financial services store component 130 can generate an online store that can be accessed by communication devices (e.g., 102, 106, 108, 110, 120, etc.) associated with financial service providers (e.g., 112, 114, 116), third-party service developers (e.g., 122), or consumers (e.g., user 104) to facilitate enabling financial service providers, third-party service developers, or consumers to access, download, and/or purchase online financial services or financial service modules from the online store. Depending in part on the online financial service or financial service module, the online financial service or financial service module can have a cost (e.g., financial cost or other cost) associated with it or it can be available at no cost.

The financial services component 124 also can comprise a search engine 132 (Search Eng. 132) that can be used to facilitate searching for online financial services or financial service modules maintained by the database(s), which can be stored in a data store associated with the financial services component 124. A communication device (e.g., 102, 106, 120, etc.) associated with a financial service provider (e.g., 112), third-party service developer (e.g., 122), or consumer (e.g., user 104) can be used to generate a search query comprising a search term, a search phrase, search category, etc., that can be provided to the search engine 132. The search engine 132 can search the database(s) to determine one or more online financial services or financial service modules that can be responsive to the search query. The search engine 132 can facilitate providing a set of search results that can provide information (e.g., search results), which can relate to the one or more online financial services or financial service modules determined to be responsive to the search query, to the communication device that provided the search query. The entity associated with the communication device, which receives the information, can use the communication device to select a search result(s) in the set of search results to facilitate accessing or obtaining an online financial service(s) or financial service module(s) associated with the selected search result(s).

The financial services component 124 also can facilitate locating new entities (e.g., financial service partners, such as financial service providers, third-party service developers, etc.), validating new entities, classifying new entities, and/or associating new entities (e.g., financial service partners) with the financial services platform 118. For instance, the financial services component 124 can be a middleman, broker, facilitator, etc., to facilitate pre-approving a third-party service developer (e.g., 122) to build on or modify an online financial service of another entity(ies) (e.g., financial service provider(s) (e.g., 112), another third-party service developer, etc.) to generate a new online financial service or to develop an online financial service or financial service modules on behalf of the other entity. The financial services component 124 also can facilitate enabling entities to become trusted or accepted entities in relation to each other, wherein there can be one or more trust or acceptance levels.

For example, there can be a first trust or acceptance level that can be a one-time trust or acceptance between two or more entities in connection with a one-time transaction (e.g., one-time approval to combine financial service module of a first entity with at least one other financial service module or online financial service associated with at least one other entity). For instance, using their respective communication devices to communicate with the financial services component 124, a first entity and a second entity can agree (and digitally sign a legally binding contract) for a one-time financial service development, wherein the financial service module associated with the first entity is to be combined or integrated with an online financial service associated with the second entity to produce a new online financial service. The agreement also can include contract terms that can provide for a defined royalty or income sharing between the first entity and the second entity for each unit of the new online financial service sold via the financial services store 130.

A second trust or acceptance level can provide for a limited trust or acceptance between two or more entities with respect to development of online financial services, wherein, for example, two or more entities can agree to make their respective financial service libraries of online financial services or financial service modules available to the other trusted or accepted entity(ies). For instance, the first entity and the second entity can be accepted entities with respect to each other with regard to their respective financial service libraries (e.g., as stored in the data store of the financial services platform 118), wherein the first entity and the second entity (e.g., via their respective communication devices) agree (e.g., via a digitally signed, legally binding electronic contract document) to allow the first or second entity to associate (e.g., combine, integrate, etc.) certain online financial services and/or financial service modules of one entity with certain online financial services and/or financial service modules of the other entity to generate new online financial services that can be offered by the financial services store 130 of the financial services platform 118. The agreement also can include contract terms that can provide for a defined royalty or income sharing (e.g., division of income) between the first entity and the second entity for each unit of the one or more new online financial services sold via the financial services store 130.

A third trust or acceptance level can be a higher trust or acceptance level than that of the first level or second level. The third trust or acceptance level can be that, in addition to the entities agreeing to make their respective libraries of online financial services and/or finance service modules available to facilitate development of new online financial services, the first entity and the second entity also can be trusted or accepted entities with respect to each other with regard to certain proprietary information associated with the respective entities and/or their respective financial service libraries, wherein the first entity and the second entity (e.g., via their respective communication devices) can agree (e.g., via a digitally signed, legally binding electronic contract document) to allow each other to have access to the certain proprietary information of the other entity to facilitate generating new online financial services. The electronic contract document between the first and second entities also can specify a defined royalty or income sharing (e.g., division of income) between the first entity and the second entity for each unit of the one or more new online financial services sold via the financial services store 130 in connection with the agreement.

For instance, the financial services component 124 can employ the electronic-signature service to facilitate the digital signing of electronic documents (e.g., electronic contract documents) and verification of the digital signatures on electronic documents to create legally binding contracts between the trusted or accepted entities, wherein the contract terms can specify the aspects of the relationship associated with the trust or acceptance level between the entities, what information is to be shared between or made available to the entities, aspects relating to royalties or income sharing in connection with online financial services developed using the technology (e.g., online financial service, financial service module, proprietary information, etc.) of multiple entities, etc.

In some implementations, the communication devices (e.g., 102, 106, 108, 110, 120, etc.) associated with users (e.g., consumers, financial service providers, third-party service developers, etc.) can comprise user financial services components that can facilitate enabling the communication devices to facilitate managing online financial services and finance service modules associated with the users (e.g., download financial services, switch financial services on or off, configure online financial services, etc.), develop (e.g., generate, create) online financial services or financial service modules, etc. For instance, the communication device 102 can comprise user financial services component (UFSC) 136, communication device 106 can comprise UFSC 138, communication device 108 can comprise UFSC 140, communication device 110 can comprise UFSC 142, and communication device 120 can comprise UFSC 142.

In some implementations, the UFSCs can be the same for the communication devices (e.g., 106, 108, 110, etc.) associated with the financial service providers (e.g., 112, 114, 116, etc.), communication device 120 associated with the third-party service developer 122, and the communication device 102 associated with the user 104 (e.g., consumer). For example, a communication device can download a user financial services application to the communication device from the financial services component 124 and can use the user financial services application to facilitate implementing the UFSC. In other implementations, a UFSC associated with one entity (e.g., consumer) can be different from a UFSC associated with another entity (e.g., financial service provider and/or the third-party service developer). For example, there can be one type of user financial services application for certain users (e.g., consumers) and a different type of user financial services application for other users (e.g., financial service provider and/or the third-party service developer).

A UFSC (e.g., 138, 138, 140, 142, and/or 144) can facilitate managing online financial services associated with a user (e.g., consumer, financial service provider, third-party service developer, etc.). For instance, a UFSC (e.g., 138, 138, 140, 142, and/or 144) can be employed to facilitate downloading an online financial service to a communication device (e.g., 102, 106, 108, 110, and/or 120), turning online financial services on or off (e.g., switching on or off add-on online financial services that can be in addition to core banking or financial services), turning a function of an online financial service on or off, configuring an online financial service, and/or performing other functions that can facilitate managing online financial services associated with a user of the communication device.

A UFSC (e.g., 138, 138, 140, 142, and/or 144) also can facilitate enabling a user (e.g., consumer, financial service provider, third-party service developer, etc.) to use the communication device (e.g., 102, 106, 108, 110, and/or 120) to develop, generate, create, modify, or update online financial services or financial service modules. A UFSC (e.g., 138, 138, 140, 142, and/or 144) can utilize APIs, API tools, or API sub-components or functions associated with the financial services component 124 to facilitate developing online financial services that can be used via the financial services platform 118. For instance, a UFSC (e.g., 138, 138, 140, 142, and/or 144) can utilize APIs, API tools, or API sub-components or functions associated with the financial services component 124 to facilitate developing one or more financial service modules and associating (e.g., combining, integrating, etc.) the one or more financial service modules to create an online financial service. A UFSC (e.g., 138, 138, 140, 142, and/or 144) can utilize the APIs, API tools, or API sub-components or functions to facilitate modifying functionality or adding new functionality to an existing online financial service to generate a modified online financial service (e.g., can modify a financial service module associated with an existing online financial service, can add a new financial service module to an existing online financial service, etc.).

As an example, a UFSC (e.g., 138, 138, 140, 142, and/or 144) can utilize the APIs, API tools, or API sub-components or functions to generate new financial service modules that can be combined to create a new online financial service. The financial services component 124 can store the new online financial service in a data store (e.g., a data store associated with the financial services platform 118), and the new online financial service can be made available (e.g., for free or at a defined cost via the financial services store component 130) to communication devices (and associated users) that are associated with the financial services platform 118.

As another example, a UFSC (e.g., 138, 138, 140, 142, and/or 144) can utilize the APIs, API tools, or API sub-components or functions to generate a new financial service module(s) that can be combined with, integrated with, added to, and/or layered on top of an existing online financial service(s) to create a new or modified online financial service, wherein the new or modified online financial service can be stored in the data store by the financial services component 124 and can be made available (e.g., via the financial services store component 130) to communication devices (and associated users) that are associated with the financial services platform 118. For instance, a UFSC (e.g., 138, 138, 140, 142, and/or 144) can utilize the APIs, API tools, or API sub-components or functions to generate a new financial service module(s) that can comprise a new (e.g., unique) user interface and the new financial service module(s) can be associated with (e.g. combined with, layered on top of, etc.) multiple online financial services, including a first online financial service and a second online financial service, which can have respective user interfaces, wherein the first online financial service can be associated with a first type of financial account and/or or a first financial service provider, and the second online financial service can be associated with a second type of financial account and/or or a second financial service provider. The new financial service module(s) can be utilized to facilitate identifying respective items of information (e.g., items of financial-related information associated with a user (e.g., consumer)) associated with the first online financial service and the second online financial service, and can facilitate coalescing, synthesizing, re-arranging, and/or otherwise processing the respective items of information to generate a modified set of items of information. The modified set of items of information (e.g., modified set of items of financial-related information) can be provided to the communication device (e.g., 102) of the user (e.g., 104) and presented to the user (e.g., on a display screen of the communication device). For example, the new financial service module(s) can present (e.g., via a new interface) the modified set of items of information, based on the respective items of information associated with the first and second online financial services, in a format that some users can find more aesthetically pleasing and/or useful than how the original respective items of information associated with the first and second online financial services were being presented via the original interfaces associated with the first and second online financial services. As some other examples, the new financial service component(s) can coalesce, synthesize, or otherwise process the respective items of information associated with the first and second online financial services to generate one or more graphs or charts of financial information (e.g., a graph or chart (e.g., pie chart) showing respective percentages of monthly income being applied to respective monthly debts in connection with the user, a graph or chart depicting a percentage or ratio of debt identified as being acceptable debt (e.g., school loans, home loan, etc.) to debt being defined as unacceptable or less desirable (e.g., credit card debt) in connection with the user, a graph or chart relating to an investment or retirement portfolio of the user, etc.), one or more financial-related percentages or ratios (e.g., debt-to-income ratio associated with the user, etc.), based at least in part on the respective items of information associated with the first and second online financial services. The new financial service module(s), which itself can be a new online financial service, and/or the combination of the new financial service module(s), the first online financial service, and the second online financial service can be stored in the data store and maintained in the financial store associated with the financial store component 130.

In some implementations, when a first entity (e.g., third-party service developer 122) desires to associate (e.g., combine, integrate, etc.) a financial service module created or associated with the first entity and an online financial service associated with a second entity (e.g., financial service provider 112), the financial services component 124 can control the associating of the financial service module and the online financial service, in accordance with a defined financial service criterion(s) and/or a preference(s) associated with the second entity. For example, the second entity can provide preference information to the financial services component 124 via a communication device (e.g., 106), wherein the preference information can indicate a preference that the online financial service associated with the second entity cannot be combined with a financial service module or other online financial service associated with another entity (e.g., first entity) unless a condition(s) is satisfied (e.g., the first entity pays a defined cost (e.g., one-time cost (e.g. financial or other type of cost), per use (or unit) cost or royalty, subscription cost, or other cost), the first entity is a trusted or accepted (e.g., approved) entity in connection with the second entity, etc.). The financial services component 124 can control the combining of the financial service module and the online financial service, in accordance with the defined financial service criterion(s) and/or the preference(s) associated with the second entity, to not allow the combining of the financial service module and the online financial service unless or until the preference associated with the second entity is satisfied.

With further regard to the open credit exchange platform 128, the open credit exchange platform 128 (also referred to herein as, e.g., an open credit exchange component) that can facilitate generating or selecting financial offers (e.g., approved financial offers) and providing financial offers to communication devices, such as communication device 102, associated with users (e.g., consumers), such as user 104, in accordance with defined financial offer criteria. At various times, the open credit exchange platform 128 can be associated with (e.g., communicatively connected to) communication device 102 to facilitate receiving information from the communication device 102 (e.g., information provided by the user 104 via the communication device 102), providing notifications of approved financial offers to the communication device 102, or providing other information to the communication device 102, etc. At various times, the open credit exchange platform 128 also can be associated with (e.g., communicatively connected to) communication device 106, communication device 108, and communication device 110 to facilitate providing information relating to consumers to the communication device 106, communication device 108, and communication device 110, receiving approved financial offers directed to users (e.g., 104) or other information from the communication device 106, communication device 108, and communication device 110, etc.

The open credit exchange platform 128 can comprise a credit management component 134 (CMC 134) that can control operations associated with the open credit exchange platform 128, and can control providing information to financial service providers (e.g., 112, 114, 116) via respective communication devices (e.g., 106, 108, 110) to facilitate generation of approved financial offers by the financial service providers, processing of approved financial offers and other information received from the financial service providers or other entities, selecting of one or more (e.g., the best or most preferred, or a subset of best or most preferred) approved financial offers in relation to a user (e.g., 104), etc., as more fully disclosed herein.

In some implementations, the open credit exchange platform 128 can be associated with (e.g., communicatively connected to) a communication device 146 that can be associated with a financial information provider 148. The financial information provider 148 can be an entity in the business of collecting, analyzing, and processing financial data relating to consumers (e.g., user 104), and/or demographic information relating to consumers. For example, the financial information provider 148 can be a consumer reporting company that can generate and maintain credit reports, financial histories, and/or financial scores (e.g., credit scores), wherein the financial information provider 148 can provide such credit reports, financial histories, and/or financial scores to other entities (e.g., the open credit exchange platform 128, financial service provider 112, financial service provider 114, financial service provider 116, user 104, etc.), for example, when such other entities are authorized or entitled to obtain such information. A financial information provider 148 also can be a store (e.g., online store, brick-and-mortar store, etc.) or another user (e.g., another user who has engaged in a financial transaction associated with the user 104 or provides other financial-related information associated with the user 104). The credit management component 134 can use the financial information received from the financial information provider 148 via the communication device 146 to facilitate providing such financial information or information relating thereto (e.g., processed or synthesized information based on such financial information) to the financial service providers 112, 114, and 116 via communication devices 106, 108, and 110, or to the user 104 via communication device 102, or processing (e.g., analyzing, evaluating, etc.) such financial information to facilitate generating information for use in making financial offers, financial decisions, etc.

The credit management component 134 can monitor and collect personal information, financial information, and/or consumer behavior information respectively associated with users 104 (e.g., consumers), and/or other relevant information. The personal information, financial information, and/or consumer behavior information can include, for example, credit history of users (e.g., as reported by financial service providers (e.g., 112, 114, 116) associated with the open credit exchange platform 128, as reported by third-party credit reporting services (e.g., financial information provider 148), etc.), personal information (e.g., name, address, marital status, number of children, etc.) of users (e.g., 104), employment history of users, consumer transaction history of user, assets and/or liabilities of users, social profile information associated with users (e.g., as provided to the open credit exchange platform by users, as obtained from a third-party social networking site, etc.), demographic information (e.g., age, sex, marital or family status, level of education, type of employment, professional affiliation or credentials (e.g., professional license(s) or registration(s)), geographic location, income bracket, cost of living in geographic region, political affiliation, etc.) associated with users, etc. The credit management component 134 can continue (e.g., continuously in real or near real time, periodically, dynamically, etc.) to monitor, collect, and/or update the personal information, financial information, consumer behavior information, and/or other relevant information to facilitate enabling the financial service providers (e.g., 112, 114, 116) to assess such information in real or near real time and generate approved financial offers to present to users (e.g., 104).

The credit management component 134 can analyze and/or classify the personal information, financial information, consumer behavior information, and/or other relevant information to facilitate providing analysis or classification results, based at least in part on such information, to the financial service providers (e.g., 112, 114, 116) associated with the open credit exchange platform 128 via the respective communication devices (e.g., 106, 108, 110). In some implementations, the credit management component 134 can provide raw data of the collected personal information, financial information, consumer behavior information, and/or other relevant information to financial service providers (e.g., 112, 114, 116) associated with the open credit exchange platform 128 via the respective communication devices (e.g., 106, 108, 110). The credit management component 134 (e.g., using the information-standardization service) also can standardize data relating to the collected personal information, financial information, consumer behavior information, and/or other relevant information to facilitate presenting such information to the financial service providers (e.g., 112, 114, 116) via the respective communication devices (e.g., 106, 108, 110). For example, the credit management component 134 can process the collected personal information, financial information, consumer behavior information, and/or other relevant information to standardize or normalize such information to correspond to a defined number (N) of financial-related parameters associated with consumers to facilitate evaluation of the financial-related information by the financial service providers (e.g., 112, 114, 116), wherein N can be virtually any desired integer number. As part of the analysis or classification of such information, the credit management component 134 also can verify respective pieces of information, assign accuracy confidence levels to respective pieces of information (e.g., rate the accuracy of a piece of information on a scale ranging from 0% to 100%), or otherwise provide an indication of the strength of the accuracy of respective pieces of data to facilitate enabling the financial service providers (e.g., 112, 114, 116) to understand the accuracy and reliability of the respective pieces of information and analyze or assess the respective pieces of information accordingly.

The credit management component 134 (e.g., using the financial-score service) also can analyze the financial-related information (e.g., personal information, financial information, consumer behavior information, and/or other relevant information) associated with the respective consumers, and can determine respective financial health scores of respective consumers (e.g., including user 104) based at least in part on the analysis of the financial-related information and defined financial assessment criteria. The credit management component 134 can make the respective financial health scores, and/or other information (e.g., the defined N financial-related parameters, confidence levels or scores for respective parameters or information, etc.), available (e.g., allow access of the financial health scores or present the financial health scores of consumers) to financial service providers (e.g., 112, 114, 116) associated with the open credit exchange platform 128 to facilitate enabling financial service providers to assess the financial risk of making approved financial offers to respective consumers (e.g., user 104) in accordance with the respective defined financial assessment criteria of the respective financial service providers. The credit management component 134 also can provide the financial health score to a communication device 102 or destination address (e.g., mobile phone number, email address, address associated with a social networking site or social networking message box, etc.) associated with the consumer (e.g., user 104) to notify the consumer of the consumer's financial health score and/or as part of providing instruction to the consumer as to how the consumer can improve the consumer's financial health score, as more fully described herein. The credit management component 134 also can use the financial health scores of consumers to facilitate generating a mapping (e.g., real-time mapping) of approved financial offers from the financial service providers (e.g., 112, 114, 116) to the consumers (e.g., user 104), as more fully described herein.

The open credit exchange platform 128 also can be an always-on, always-updating platform (e.g., the system 100, including the open credit exchange platform 128 and credit management component 134, can be always-on and always-updating in real or near real time with regard to updating of financial health scores or other financial-related information associated with consumers, identifying or selecting a preferred approved financial offer(s) for a consumer, notifying consumers regarding the preferred approved financial offer(s), etc.). For instance, the credit management component 134 can continue to monitor (e.g., automatically or dynamically monitor (e.g., dynamically monitor in response to a detected financial event), monitor in real or near real time) information relating to consumers, such as user 104. The credit management component 134 can update or modify (e.g., automatically, dynamically, or in real or near real time) the respective financial health scores of respective consumers based at least in part on evaluation of the monitored information and previous information (e.g., financial-related information) relating to the consumers, can store the updated or modified financial health scores of the respective consumers in respective user profiles of the consumers, and/or can make the updated or modified financial health scores of the respective consumers available to communication devices (e.g., 106, 108, 110) associated with the financial service providers (e.g., 112, 114, 116) and/or respective communication devices (e.g., 102) associated with the respective consumers (e.g., user 104).

With further regard to the financial service providers (e.g., 112, 114, 116), the communication devices (e.g., 106, 108, 110) of the financial service providers (e.g., 112, 114, 116) associated with (e.g., registered with, approved by, utilizing, etc.) the open credit exchange platform 128 can access or receive information (e.g., financial-related information, such as personal information, financial information, consumer behavior information, financial health scores, and/or other relevant information (e.g., demographic information); standardized or normalized information (e.g., the defined N financial-related parameters) based at least in part on the personal information, financial information, consumer behavior information, financial health scores, and/or other relevant information; other financial-related information (e.g., confidence levels or scores associated with respective items or information or parameters); etc.) from the credit management component 134 of the open credit exchange platform 128. The communication devices (e.g., 106, 108, 110) of the financial service providers (e.g., 112, 114, 116) can include or be associated with financial-service-provider (FSP) credit management components, such as FSP credit management component 150 (FSP CMC 150), FSP credit management component 152 (FSP CMC 152), and FSP credit management component 154 (FSP CMC 154). The FSP credit management components (e.g., 150, 152, 154) can respectively analyze (e.g., in real or near real time) the information received from the credit management component 134 of the open credit exchange platform 128 to facilitate respectively determining or identifying financial offers (e.g., approved credit offers) that the respective financial service providers (e.g., 112, 114, 116) desire to make to respective consumers (e.g., user 104) associated with the received information, in accordance with respective defined financial assessment criteria (e.g., defined financial offer or risk criteria) associated with the financial service providers (e.g., 112, 114, 116).

An FSP credit management component (e.g., 150, 152, 154) of a financial service provider (e.g., 112, 114, 116) can determine and generate approved (e.g., pre-approved, unconditionally approved) financial offers directed to respective users (e.g., user 104), based at least in part on the analysis of received information (e.g., personal information, financial information, consumer behavior information, and/or other relevant information; standardized or normalized information based at least in part on the personal information, financial information, consumer behavior information, and/or other relevant information; other financial-related information; etc.), and the defined financial assessment criteria associated with the particular financial service provider (e.g., 112, 114, 116). In some implementations, an FSP credit management component (e.g., 150, 152, 154) can structure the approved financial offers in a standardized form, in accordance with defined financial offer criteria (e.g., as specified by the credit management component 134), to facilitate providing standardized approved financial offers to consumers (e.g., user 104) for an easy comparison by users (e.g., essentially an “apples-to-apples” comparison rather than an “apples-to-oranges” comparison). The FSP credit management components (e.g., 150, 152, 154) of respective financial service providers (e.g., 112, 114, 116) can provide approved financial offers directed to respective users (e.g., user 104) to the open credit exchange platform 128 for further processing.

For each user, the credit management component 134 can receive or identify a set of approved financial offers directed to the user from one or more FSP credit management components (e.g., 150, 152, 154) of one or more respective financial service providers (e.g., 112, 114, 116) associated with the open credit exchange platform 118. The credit management component 134 can analyze or evaluate the approved financial offers in the set of approved financial offers to facilitate identifying or determining desirable approved financial offers, in accordance with the defined financial offer criteria. The credit management component 134 can identify or determine one or more desirable (e.g., the best or most preferred, or a subset of best or most preferred) approved financial offers from the set of approved financial offers directed to the user for presentation to the communication device 102 of the user 104.

For example, the credit management component 134 can determine or calculate a respective financial offer value (e.g., financial offer rating, financial offer score, etc.) for each approved financial offer in the set of approved financial offers based at least in part on the evaluation of the approved financial offers and in accordance with the defined financial offer criteria (and/or corresponding financial offer rules). The credit management component 134 can rank or order the approved financial offers in relation to each other based at least in part on their respective financial offer values (e.g., rank the approved financial offers from highest value to lowest value (or lowest value to highest value)). The credit management component 134 can identify the approved financial offer having the highest financial offer value as being the most desirable (e.g., best, most preferred, optimal, etc.) approved financial offer of the set of approved financial offers, and, as desired (e.g., when in accordance with the defined financial offer criteria), can identify an approved financial offer having the second highest financial offer value as being the second most desirable (e.g., second best or highest) approved financial offer of the set of approved financial offers, and so on. In some implementations (e.g., when in accordance with the defined financial offer criteria), the credit management component 134 can identify the preferred approved financial offer and/or one or more other approved financial offers in the set that meet or exceed a defined threshold (e.g., minimum threshold) financial offer value for selection and presentation to the consumer (e.g., user 104), and/or can select the preferred approved financial offer and/or one or more other approved financial offers in the set that meet or exceed the defined threshold financial offer value. The one or more desirable approved financial offers can be the preferred approved financial offer and/or the one or more other approved financial offers in the set that meet or exceed the defined threshold financial offer value.

The credit management component 134 can transmit the one or more desirable (e.g., most preferred or subset of most preferred) approved financial offers to the communication device 102 of the user 104, for example, via a push notification operation (e.g., the credit management component 134 can automatically, dynamically, or periodically push the approved financial offers to the communication device 102 of the user 104) or a pull notification operation (e.g., the communication device 102 can automatically, dynamically, periodically, or in response to a request for the approved financial offers from the user 104 of the communication device 102, request the approved financial offers from the credit management component 134). The notification of an approved financial offer can be in the form of, for example, a notification message associated with the financial application, a text message, an email message, or a voice mail message. A text message can be, for example, a short message service (SMS) message, an instant message (IM), a multimedia message (e.g., a multimedia messaging service (MMS) message), etc.

The communication device 102 (e.g., computer, mobile phone, electronic tablet, etc.) of the user 104 can receive the one or more desirable (e.g., the best or most preferred, or a subset of best or most preferred) approved financial offers, and/or notifications of such approved financial offers, from the credit management component 134. In some implementations, the communication device 102 can include (as depicted) or can access (e.g., via a web site) a consumer finances management component 156 (CFMC 156) that can be employed by the user 104 (e.g., consumer) to facilitate managing the finances of the user 104, accessing and/or using a digital wallet of the user 104, reviewing and/or accepting approved financial offers, executing financial transactions (e.g., making online or electronic payments for debts, goods, or services; accepting an approved financial offer and/or executing a contract; etc.), identifying a financial health or strength of the user 104, etc., as more fully described herein.

With regard to the one or more received approved financial offers, and/or notifications of such approved financial offers, the consumer finances management component 156 can process and present the one or more received approved financial offers and/or notifications of such approved financial offers to the user 104 via an interface(s) of the communication device 102. If the received information is a notification of an approved financial offer(s), the user 104 can use the consumer finances management component 156 to generate a message that can be sent to the open credit exchange platform 128 to facilitate obtaining further information regarding the approved financial offer(s) from the open credit exchange platform 128.

When the communication device 102 has the information relating to approved financial offer(s), the user 104 can review the approved financial offer(s) on the communication device 102. If the user 104 decides to accept an approved financial offer, the user 104 can use the user's communication device 102 to access a contract associated with the approved financial offer, and can enter the user's electronic signature on the contract relating to the approved financial offer. For example, the user 104 can select a control (e.g., button, icon, etc.) on a user interface on the communication device 102 to accept the approved financial offer, and the communication device 102 can present the contract to the user 104 for signature (e.g., electronic signature) via the user interface (e.g., the contract can be provided with the approved financial offer when the offer is initially sent or can be provided to the communication device 102 by the credit management component 134 for presentation to the user 104 in response to the user 104 accepting the approved financial offer). The consumer finances management component 156 can employ a defined security protocol(s) (e.g., authentication and/or cryptographic protocols) to facilitate secure execution (e.g., electronic signing) of the contract by the user 104, as more fully disclosed herein.

The consumer finances management component 156 can facilitate transmitting (e.g., via a secure communication channel) the signed (e.g., executed) contract to the open credit exchange platform 128. The credit management component 134 of the open credit exchange platform 128 can evaluate the signed contract and can verify the signature (e.g., electronic signature) of the user 104 to facilitate validating and creating a legally binding contract relating to the approved financial offer. In accordance with various implementations, the credit management component 134 can electronically sign (e.g., automatically) the contract on behalf of the financial service provider that made the approved financial offer, can provide the contract to the financial service provider for signature (e.g., automatic signature) by the financial service provider, or the approved financial offer can be executed by the financial service provider prior to presenting the approved financial offer to the open credit exchange platform 128 for presentation to the communication device 102 of the user 104.

In response to validating the legally binding contract (e.g., electronic document comprising the legally binding contract) relating to the approved financial offer, the credit management component 134 can apply or deposit (e.g., automatically or instantaneously applied or deposited) the monetary funds or credit associated with the approved financial offer (and contract) to a financial account or financial transaction associated with the user 104. In some implementations, the user 104 can be registered with the open credit exchange platform 128 and can have a financial account in which funds can be deposited or credit can be applied and/or, at the time of accepting the approved financial offer or signing the contract, the user 104 can use the communication device 102 to enter information identifying a financial account to which the user 104 desires the funds or credit to be deposited or applied. In other implementations, it is not necessary for the user 104 to be registered with the open credit exchange platform 128, and, at the time of accepting the approved financial offer or signing the contract, the user 104 can use the communication device 102 to enter information identifying a financial account to which the user 104 desires the funds or credit to be deposited or applied.

As a result, the user 104 can be provided the financial benefit (e.g., monetary funds or credit, and associated financial conditions) associated with the approved financial offer (e.g., in relation to the purchase of a product or service), and the financial service provider (e.g., 112) can be provided the financial benefit (e.g., interest and fees relating to the extension of credit) as provided in the legally binding contract. Further, it is not necessary for the user 104 to prepare and submit a credit or loan application for consideration and approval by a financial service provider (e.g., 112), since the financial offer presented to the user has already been approved by the financial service provider (e.g., 112) based at least in part on the information previously made available to the financial service provider (e.g., 112) by the open credit exchange platform 128 and the defined financial assessment criteria of the financial service provider (e.g., 112).

In accordance with various aspects, the credit management component 134 of the open credit exchange platform 128 can facilitate securing data, and protecting the privacy of users associated with the open credit exchange platform 128. In some implementations, the credit management component 134 can expose information relating to consumers in an anonymous manner to FSP credit management components (e.g., 150, 152, 154) of the respective financial service providers (e.g., 112, 114, 116) associated with the open credit exchange platform 128, so that the financial service providers (e.g., 112, 114, 116) are not able to identify a consumer (e.g., user 104) by the consumer's actual identity, but are able to view financial-related information associated with the consumer, wherein the financial-related information associated with the consumer can be associated with a unique pseudo name or number. For example, the credit management component 134 can associate (e.g., link, map, etc.) financial-related information with a consumer identification (ID) number or name (e.g., a pseudo number or name) to facilitate obscuring the consumer's actual name from the FSP credit management components (e.g., 150, 152, 154) and respectively associated financial service providers (e.g., 112, 114, 116), wherein the credit management component 134 can make the consumer ID number of name available to the FSP credit management components (e.g., 150, 152, 154) with the associated financial-related information of the consumer without allowing the FSP credit management components (e.g., 150, 152, 154) to obtain or identify the actual name of the consumer. In certain implementations, the credit management component 134 can enable a consumer (e.g., user 104), using the consumer's communication device 102, to control the information (e.g., control the type or amount of information) of the consumer that is exposed to (e.g., made available to) the FSP credit management components (e.g., 150, 152, 154) and respectively associated financial service providers (e.g., 112, 114, 116). The credit management component 134 and/or the consumer's communication device 102 (e.g., via the financial application used by the communication device 102) can provide for transparency of the data by enabling the consumer to perceive and know which information of the consumer is being exposed to the FSP credit management components (e.g., 150, 152, 154) and respectively associated financial service providers (e.g., 112, 114, 116). The credit management component 134 and the consumer's communication device 102 (e.g., via the financial application) can employ an authentication protocol(s) or algorithm(s) to further facilitate securing data and financial transactions associated with the consumer in relation to the open credit exchange platform 128.

With further regard to the consumer finances management component 156 of the communication device 102, the consumer finances management component 156 can be provided to or accessed by the communication device 102 using an application (e.g., financial application). For example, the communication device 102 can download the application and install the application on the communication device 102 to facilitate installing the consumer finances management component 156 on the communication device 102. Additionally and/or alternatively, the application can be a web-based application, wherein the communication device 102 can access the application and the consumer finances management component 156 via a web browser of the communication component 102.

The consumer finances management component 156 can facilitate providing (e.g., presenting), for example, a digital wallet that can enable the user 104 to view all or a desired portion of the financial accounts (e.g., bank account(s), credit or loan account(s), etc.), available approved financial offers, bills (e.g., billing statement for a payment due on a credit account), financial transaction history, financial health or strength, and/or other information (e.g., user preferences) associated with the user 104. The digital wallet can provide (e.g., present, display, etc.) the current purchasing power (e.g., including available purchasing power via an approved financial offer(s)) of the user 104 to the user 104, wherein, the current purchasing power can include current assets (e.g., liquid assets, such as money in a bank account), open lines of credit, available lines of credit through approved financial offers, etc. The consumer finances management component 156 (e.g., through use of the digital wallet) can facilitate enabling the user 104 to view and/or accept an approved financial offer, execute a contract (e.g., electronically sign an electronic contract document relating to an approved financial offer), make a payment on a financial transaction, bill, or account, transfer monetary funds between accounts of the user 104, registering or providing information relating to accounts of the user 104, create a user profile, select or modify user preferences, and/or perform other functions or transactions.

The consumer finances management component 156 also can facilitate setting preferences of the user 104 with regard to data security (e.g., security of information relating to the user 104 and/or secure control of data of the user 104 that is exposed) by the open credit exchange platform 128 and/or communication device 102, selection of approved financial offers by the open credit exchange platform 128, conditions under which the open credit exchange platform 128 is to refinance (e.g., automatically) an account(s) of the user 104 or notify the user 104 of an opportunity to refinance an account(s), notification of the user 104 in relation to financial health (e.g., in relation to a change in financial health or strength, in relation to instruction to facilitate improving financial health or strength), and/or other functions associated with the consumer finances management component 156 or credit management component 134. The consumer finances management component 156 can store the user preferences in a user profile of the user 104, which can be stored in a data store, and can provide (e.g., transmit) the user profile and/or user preferences to the open credit exchange platform 128, wherein the credit management component 134 can store the user preferences (e.g., in the user profile generate by the communication device 102 or in a user profile generated by the credit management component 134). The credit management component 134 can implement the user preferences to facilitate identifying or selecting approved financial offers for the user 104, securing data associated with the user 104, identifying a financial health of the user 104, sending notifications to the user 104, etc.

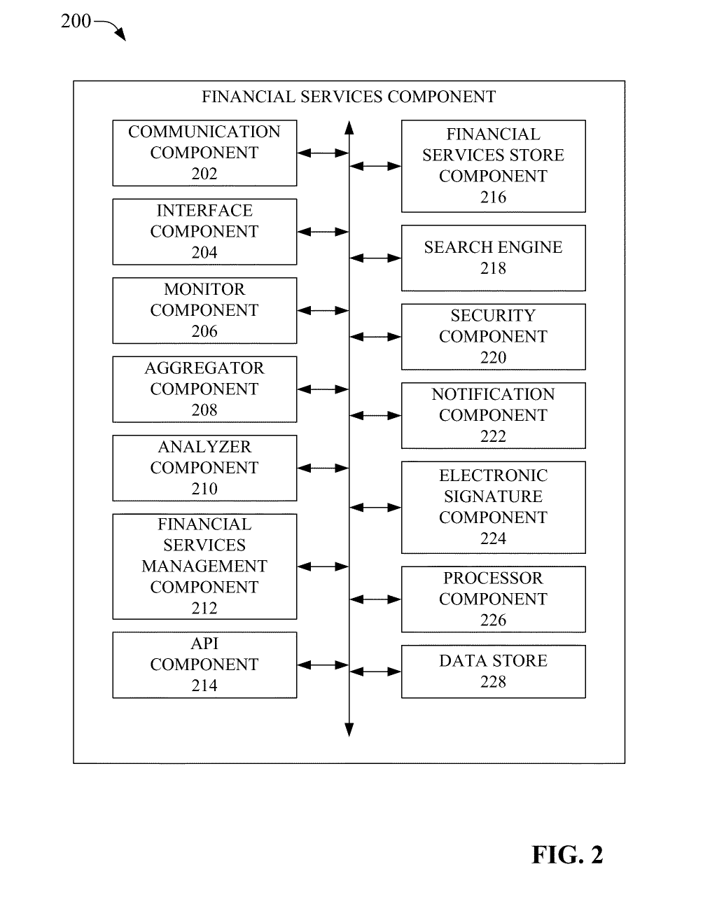

FIG. 2 illustrates a block diagram of an example financial services component 200, in accordance with various aspects and embodiments of the disclosed subject matter. The financial services component 200 can be part of or associated with a financial services platform, for example.

The financial services component 200 can comprise a communication component 202 that can communicate (e.g., transmit, receive) information, including information relating to online financial services, financial service modules, financial services store, search results relating to searches for online financial services or financial service modules, electronic documents comprising contracts, notifications, financial-related information associated with users (e.g., consumers), user preferences or selections, and/or other information, between the financial services component 200 and other components or devices, such as communication devices associated with consumers, financial service providers, third-party service developers, financial information providers, and/or other users. The communication component 202 can employ one or more communication protocols to facilitate controlling data or voice flows, and/or wireless or wireline communication of traffic (e.g., voice or data traffic), associated with the financial services component 200.

The financial services component 200 can include an interface component 204 that can comprise one or more interfaces, including one or more controls, switches, adapters, connectors, buttons, routers, speakers, display screens, graphical user interfaces (GUIs), and/or touch screen GUIs, etc., that can facilitate enabling the financial services component 200 to interface and/or communicate with other systems, components, or devices (e.g., communication devices associated with consumers, financial service providers, third-party service developers, or financial information providers; systems, components, or devices associated with a communication network(s); etc.), or users (e.g., administrators, engineers, technicians, etc.) associated with the financial services platform. The interface component 204 can facilitate establishing a communication channel (e.g., a secure wireless or wireline communication channel) between the financial services component 200 and a communication device (e.g., of a consumer, financial service provider, third-party service developer, financial information provider, etc.) associated with the financial services platform.

The financial services component 200 can comprise a monitor component 206 that can monitor (e.g., continuously, periodically, dynamically (e.g., in response to a condition for monitoring information being satisfied), etc.) information in real or near real time. The monitor component 206 can monitor, for example, information relating to online financial services and financial service modules, financial-related information associated with respective users (e.g., as directly obtained by the financial services component 200; as obtained from communication devices associated with financial service providers, financial information providers, consumers; etc.), user preferences, etc.

The financial services component 200 also can contain an aggregator component 208 that can aggregate or collect the information (e.g., information relating to online financial services, financial service modules, financial services store, search results relating to searches for online financial services or financial service modules, electronic documents comprising contracts, notifications, financial-related information associated with users (e.g., consumers), user preferences or selections, etc.). For instance, the aggregator component 208 can aggregate information received (e.g., obtained) from various entities or components (e.g., monitor component 206 or another component(s) of the financial services component 200, communication network, an application (e.g., a financial application, which can be a mobile or web application), a server or other communication device, processor, data store, etc.). The aggregator component 208 can correlate respective items of data based at least in part on type of data (e.g., information relating to a particular financial transaction, information relating to a particular online financial service or financial service module, metadata, etc.), an entity (e.g., consumer, financial service provider, third-party service developer, financial information provider, etc.) to which the data relates, source of the data, time or date the data was generated or received, etc., to facilitate analyzing or evaluating of the data by the analyzer component 210 or another component of the financial services component 200.

The analyzer component 210 can analyze, evaluate, and/or parse information (e.g., information relating to online financial services, financial service modules, financial services store, search results relating to searches for online financial services or financial service modules, electronic documents comprising contracts, notifications, financial-related information associated with users (e.g., consumers), user preferences or selections, etc.) to facilitate managing the creation of online financial services or financial service modules, determining whether an online financial service(s) or financial service module(s) can be associated with another online financial service(s) or financial service module(s) to facilitate creating a new online financial service, determining whether users are trusted or accepted in relation to each other, determining a trust or acceptance level between users, managing sales associated with the financial services store, modifying a user profile relating to a user (e.g., consumer, financial service provider, third-party service developer, etc.), verifying an electronic (e.g., a digital) signature of a user, etc. The analyzer component 210 can generate analysis results based at least in part on the analyzing, evaluating, and/or parsing of such information, and can provide the analysis results to another component(s) (e.g., financial services management component 212, API component 214, processor component 226, etc.) for further processing.

The financial services component 200 can comprise a financial services management component 212 that can facilitate managing operations associated with the financial services component 200. For example, the financial services management component 212 can control operations associated with various components (e.g., the analyzer component 210, the API component 214, etc.) to facilitate generating a new online financial service. The financial services management component 212 also can facilitate the turning on and turning off of online financial services (e.g., add-on online financial services) associated with a consumer based at least in part on preferences or selections associated with the consumer that are received from a communication device associated with the consumer.

The financial services component 200 also can include an API component 214 that can comprise APIs and API sub-components (e.g., API tools, processes, functions, etc.) that can be made available to communication devices associated with users (e.g., financial service providers, third-party service developers, etc.) that are associated with the financial services platform. The financial services component 200 and/or communication devices associated with the financial services platform can use the APIs and API sub-components associated with the API component 214 to facilitate developing or generating online financial services or financial service modules.

The financial services component 200 further can contain a financial services store component 216 that can facilitate providing a financial services store that can comprise online financial services and financial service modules. The financial services store component 216 can sell, or provide at no cost, the online financial services and financial service modules, in accordance with the respective preferences of the respective owners of the online financial services and financial service modules. The online financial services and financial service modules can be stored in the data store 228, wherein online financial services and/or financial service modules owned or developed by respective users (e.g., financial service providers, third-party developers, etc.) can be maintained in respective electronic libraries of those users.

The financial services component 200 also can include a search engine 218 that can facilitate searching for online financial services or financial service modules associated with the financial services store. For example, the search engine 218 can receive a search query from a communication device associated with a user (e.g., consumer, financial service provider, third-party service developer, etc.), wherein the search query can comprise one or more words or phrases that can facilitate determining one or more online financial services or financial service modules that can be responsive to the search query. The search query also can be augmented to include one or more other words or phrases based at least in part on a category or sub-category selected by a user in connection with the search query. The search engine 218 can search the financial services store (e.g., the information associated with the financial services store that is stored in the data store 228) to identify one or more online financial services or financial service modules that can be responsive to the search query based at least in part on the words or phrases associated with the search query. The search engine 218 can facilitate providing the one or more online financial services or financial service modules that are responsive to the search query as search results, wherein the interface component 204 can facilitate providing the search results to a communication device associated with the user that submitted the search query. In some implementations, the search engine 218 also can be employed, for example, by the financial services component 200, to facilitate determining or identifying (e.g., automatically determining or identifying) an online financial service(s) (e.g., associated with a first entity) and/or a financial service module(s) (e.g., associated with a second entity) that can be associated (e.g., combined, integrated, etc.) with each other to facilitate producing a new online financial service, based at least in part on a search query.

The financial services component 200 can comprise a security component 220 that can secure data associated with the financial services platform. The security component 220 can operate in conjunction with the communication component 202 to establish a secure communication channel between the financial services platform and communication devices associated with users (e.g., consumers, financial service providers, third-party service developers, financial information providers, etc.), in accordance with a defined security protocol(s) and defined security criteria. For example, the security component 220 can establish a secure communication channel in accordance with a secure sockets layer (SSL) protocol and/or other cryptographic protocol. The security component 220 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.).

The financial services component 200 also can comprise a notification component 222 that can generate notifications (e.g., notification messages) relating to online financial services or financial service modules (e.g., relating to a potential association of an online financial service(s) with a financial service module(s), potential association of a financial service module(s) with another financial service module(s), etc.). The notification component 222 also can generate a notification in connection with a recommendation for two or more entities (e.g., financial service provider, third-party service developer, etc.) to become accepted or trusted entities in relation to each other, as more fully disclosed herein.

The financial services component 200 can contain an electronic signature component 224 that can verify or authenticate an electronic signature of an entity(ies) (e.g., consumer, financial service provider, third-party service developer, etc.) in relation to a contract (e.g., an electronic document that includes a contract) between a first entity and at least one other entity in connection with a transaction (e.g., generation of a new financial service associated with technology of the first entity and the at least one other entity, a sale or other provision of an online financial service from the financial services store, etc.). The electronic signature component 224 (e.g., operating in conjunction with the security component 220) can evaluate an electronic signature provided by a user and can determine whether the electronic signature provided by the user is valid or verified, in accordance with the defined security criteria. For instance, if the electronic signature component 224 verifies an electronic signature of a consumer on an electronic contract document associated with a transaction, the financial services component 200 can determine that a legally binding contract is created between the entities associated with the transaction.

The financial services component 200 also can comprise a processor component 226 that can work in conjunction with the other components (e.g., communication component 202, interface component 204, monitor component 206, etc.) to facilitate performing the various functions of the financial services component 200. The processor component 226 can employ one or more processors, microprocessors, or controllers that can process data, such as information (e.g., information relating to online financial services and financial service modules, financial-related information, etc.) relating to users associated with the financial services platform, information relating to cryptography or authentication (e.g., information relating to defined security, cryptographic, and/or authentication protocols), information relating to other operations of the financial services component 200, and/or other information, etc., to facilitate operation of the financial services component 200, as more fully disclosed herein, and control data flow between the financial services component 200 and other components (e.g., other components of or associated with the financial services component 200).

The financial services component 200 also can include a data store 228 that can store data structures (e.g., user data, metadata), code structure(s) (e.g., modules, objects, hashes, classes, procedures) or instructions, information (e.g., information relating to online financial services and financial service modules, financial-related information, etc.) relating to users associated with the financial services platform, information relating to cryptography or authentication (e.g., information relating to defined security, cryptographic, and/or authentication protocols), information relating to other operations of the financial services component 200, and/or other information, etc., to facilitate controlling operations associated with the financial services component 200. In an aspect, the processor component 226 can be functionally coupled (e.g., through a memory bus) to the data store 228 in order to store and retrieve information desired to operate and/or confer functionality, at least in part, to the communication component 202, interface component 204, monitor component 206, etc., and/or substantially any other operational aspects of the financial services component 200.

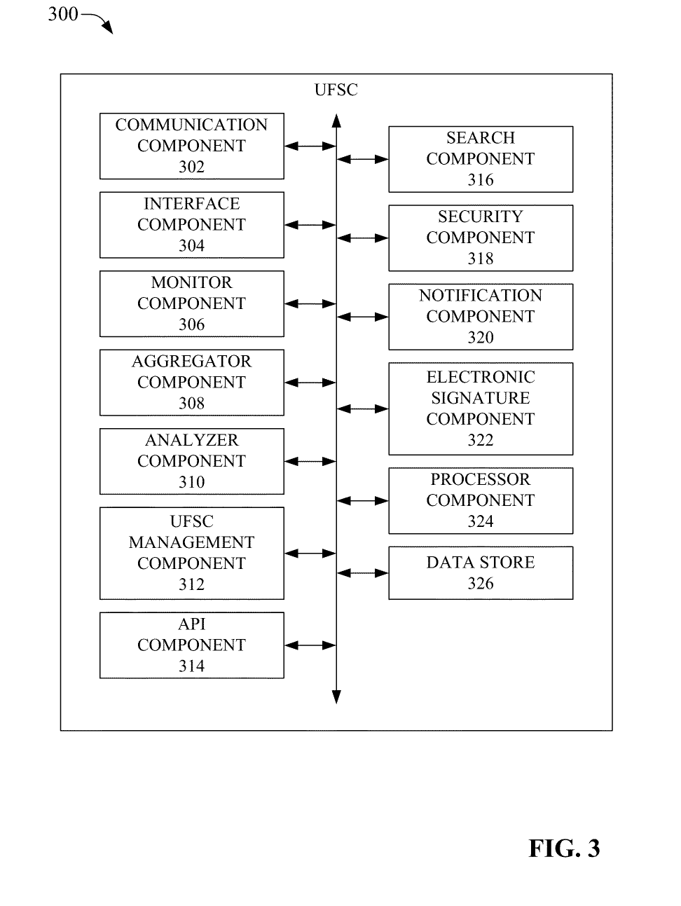

FIG. 3 illustrates a block diagram of an example UFSC 300, in accordance with various aspects and embodiments of the disclosed subject matter. The UFSC 300 can be part of or associated with a communication device associated with a user (e.g., consumer, financial service provider, third-party service developer, etc.), for example.

The UFSC 300 can comprise a communication component 302 that can communicate (e.g., transmit, receive) information, including information relating to online financial services, financial service modules, financial services store, search results relating to searches for online financial services or financial service modules, electronic documents comprising contracts, notifications, financial-related information associated with users (e.g., consumers, financial service providers, etc.), user preferences or selections, and/or other information, between the UFSC 300 and other components or devices, such as communication devices associated with other users (e.g., other consumers, financial service providers, third-party service developers, financial information providers, etc.). The communication component 302 can employ one or more communication protocols to facilitate controlling data or voice flows, and/or wireless or wireline communication of traffic (e.g., voice or data traffic), associated with the UFSC 300.

The UFSC 300 can include an interface component 304 that can comprise one or more interfaces, including one or more controls, switches, adapters, connectors, buttons, routers, speakers, display screens, graphical user interfaces (GUIs), and/or touch screen GUIs, etc., that can facilitate enabling the UFSC 300 to interface and/or communicate with other systems, components, or devices (e.g., communication devices associated with consumers, financial service providers, third-party service developers, or financial information providers; systems, components, or devices associated with a communication network(s); etc.), or users (e.g., administrators, engineers, technicians, etc.) associated with the financial services platform. The interface component 304 can facilitate establishing a communication channel (e.g., a secure wireless or wireline communication channel) between the UFSC 300 and a communication device (e.g., of another consumer, financial service provider, third-party service developer, financial information provider, etc.) associated with the UFSC 300.

The UFSC 300 can comprise a monitor component 306 that can monitor (e.g., continuously, periodically, dynamically (e.g., in response to a condition for monitoring information being satisfied), etc.) information in real or near real time. The monitor component 306 can monitor, for example, information relating to online financial services and financial service modules, notifications relating to online financial services and financial service modules, financial-related information associated with respective users, user preferences, etc.

The UFSC 300 also can contain an aggregator component 308 that can aggregate or collect the information (e.g., information relating to online financial services, financial service modules, search results relating to searches for online financial services or financial service modules, electronic documents comprising contracts, notifications, financial-related information associated with users (e.g., consumers), user preferences or selections, etc.). The aggregator component 308 can correlate respective items of data based at least in part on type of data (e.g., information relating to a particular financial transaction, information relating to a particular online financial service or financial service module, metadata, etc.), an entity (e.g., consumer, financial service provider, third-party service developer, financial information provider, etc.) to which the data relates, source of the data, time or date the data was generated or received, etc., to facilitate analyzing or evaluating of the data by the analyzer component 310 or another component of the UFSC 300.

The analyzer component 310 can analyze, evaluate, and/or parse information (e.g., information relating to online financial services, financial service modules, financial services store, search results relating to searches for online financial services or financial service modules, electronic documents comprising contracts, notifications, financial-related information associated with users (e.g., consumers), user preferences or selections, etc.) to facilitate creation of online financial service or financial service module, determining whether an online financial service(s) or financial service module(s) can be associated with another online financial service(s) or financial service module(s) to facilitate creating a new online financial service, processing a transaction (e.g., a transaction for the purchase or procurement of an online financial service or a financial service module), modifying a user profile relating to a user (e.g., consumer, financial service provider, third-party service developer, etc.), etc. The analyzer component 310 can generate analysis results based at least in part on the analyzing, evaluating, and/or parsing of such information, and can provide the analysis results to another component(s) (e.g., UFSC management component 312, API component 314, processor component 324, etc.) for further processing.

The UFSC 300 can comprise a UFSC management component 312 that can facilitate managing operations associated with the UFSC 300. For example, the UFSC management component 312 can control operations associated with various components associated with the UFSC 300 to facilitate generating a new online financial service, processing a transaction involving an online financial service and/or financial service component contained in a financial services store, searching for online financial services or financial service modules associated with the financial services platform, etc. When the UFSC 300 is associated with a communication device of a consumer, the UFSC management component 312 also can facilitate turning on and turning off online financial services (e.g., add-on online financial services) associated with the consumer based at least in part on preferences or selections associated with the consumer that are received via a communication device associated with the consumer that includes or is associated with the UFSC 300.

The UFSC 300 also can include a user API component 314 that can facilitate using APIs and API sub-components (e.g., API tools, processes, functions, etc.), which are associated with the financial services platform, to develop or generate online financial services or financial service modules, in accordance with the defined API protocol(s). The user API component 314 can operate in cooperation with the API component of the financial services platform to facilitate the developing or generating of online financial services or financial service modules.

The UFSC 300 further can comprise a search component 316 that can facilitate searching for online financial services or financial service modules associated with the financial services store. For example, the search component 316 can generate a search query, comprising a word(s) and/or phrase(s), via the interface component 304 of the UFSC 300 based at least in part on user input to a communication device comprising or associated with the UFSC 300. For instance, the search query can comprise one or more words or phrases that can facilitate determining one or more online financial services or financial service modules that can be responsive to the search query. The search query also can be augmented to include one or more other words or phrases based at least in part on a category or sub-category selected by a user in connection with the search query. The UFSC 300 can communicate (e.g., via the communication component 302) the search query to a search engine associated with the financial services platform to facilitate searching the financial services store to identify one or more online financial services or financial service modules that can be responsive to the search query based at least in part on the words or phrases associated with the search query. The UFSC 300 can receive search results responsive to the search query from the financial services platform, and the interface component 304 can facilitate presenting the search results to the communication device associated with the user that submitted the search query.

The UFSC 300 can comprise a security component 318 that can secure data associated with the UFSC 300. The security component 318 can operate in conjunction with the communication component 302 to establish a secure communication channel between the UFSC 300 and communication devices associated with the financial services platform or other users (e.g., consumers, financial service providers, third-party service developers, financial information providers, etc.), in accordance with a defined security protocol(s) and defined security criteria. For example, the security component 318 can establish a secure communication channel in accordance with an SSL protocol and/or other cryptographic protocol. The security component 318 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, PKI, DSS, DES, triple-DES, AES, cryptographic hash functions, etc.).

The UFSC 300 also can include a notification component 320 that can receive notifications (e.g., notification messages) relating to online financial services or financial service modules (e.g., relating to a potential association of an online financial service(s) with a financial service module(s), potential association of a financial service module(s) with another financial service module(s), relating to a recommendation for an entity associated with the UFSC 300 to be a trusted or accepted entity with another entity, etc.). A received notification message can be presented to the user via a display screen associated with the interface component 304.

The UFSC 300 also can contain an electronic signature component 322 that can facilitate enabling the user to electronically (e.g., digitally) sign contracts (e.g., electronic document comprising a contract) relating to transactions (e.g., purchase or procurement of online financial services or financial service modules, agreement with another entity in connection with development of an online financial service involving technology associated with the other entity, etc.) for which the user desires to enter into a contract and/or other electronic documents for which an electronic signature is desired or required. An electronically signed contract can be a legally binding contract (e.g., when it is verified) between the user and the other entity(ies) associated with the contract. In some implementations, the electronic signature component 322 can operate in conjunction with the security component 318 to facilitate applying an electronic signature to an electronic document (e.g., contract) in a secure manner, ensuring that the electronic signature is actually being made by the user or other authorized entity (e.g., using an authentication protocol(s)), etc.

The UFSC 300 also can comprise a processor component 324 that can work in conjunction with the other components (e.g., communication component 302, interface component 304, monitor component 306, etc.) to facilitate performing the various functions of the UFSC 300. The processor component 324 can employ one or more processors, microprocessors, or controllers that can process data, such as information (e.g., information relating to online financial services and financial service modules, financial-related information, etc.) relating to a user(s) associated with the UFSC 300, information relating to cryptography or authentication (e.g., information relating to defined security, cryptographic, and/or authentication protocols), information relating to other operations of the UFSC 300, and/or other information, etc., to facilitate operation of the UFSC 300, as more fully disclosed herein, and control data flow between the UFSC 300 and other components (e.g., other components of or associated with the UFSC 300).

The UFSC 300 also can include a data store 326 that can store data structures (e.g., user data, metadata), code structure(s) (e.g., modules, objects, hashes, classes, procedures) or instructions, information (e.g., information relating to online financial services and financial service modules, financial-related information, etc.) relating to a user(s) associated with the UFSC 300, information relating to cryptography or authentication (e.g., information relating to defined security, cryptographic, and/or authentication protocols), information relating to other operations of the UFSC 300, and/or other information, etc., to facilitate controlling operations associated with the UFSC 300. In an aspect, the processor component 324 can be functionally coupled (e.g., through a memory bus) to the data store 326 in order to store and retrieve information desired to operate and/or confer functionality, at least in part, to the communication component 302, interface component 304, monitor component 306, etc., and/or substantially any other operational aspects of the UFSC 300.

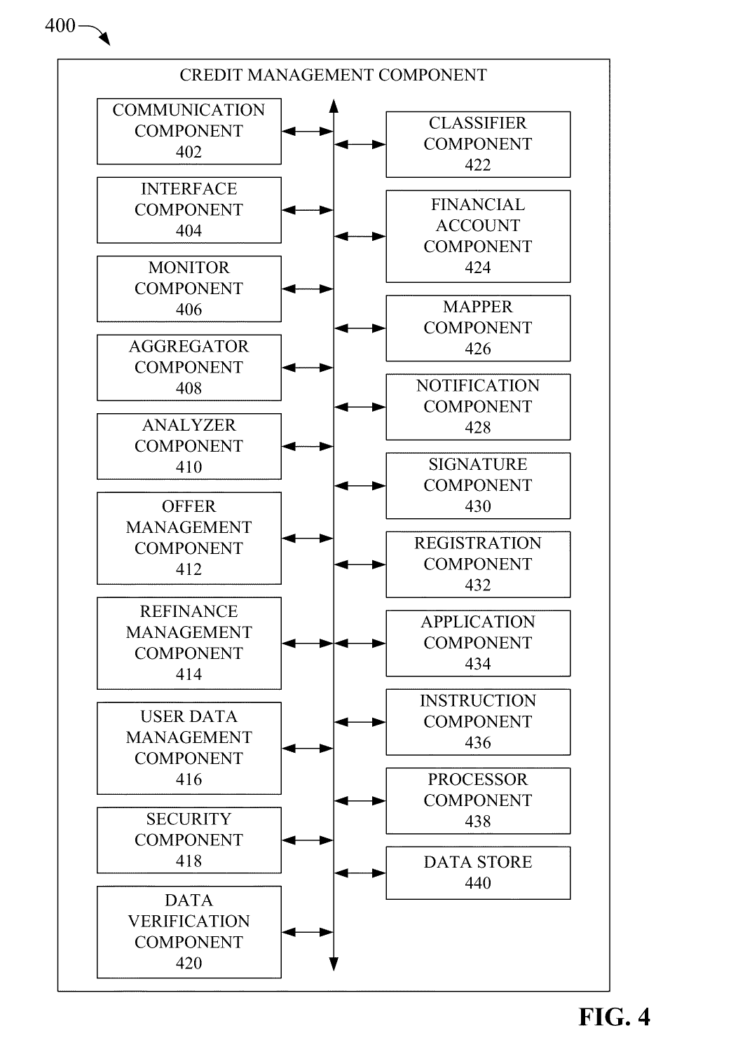

FIG. 4 depicts a block diagram of an example credit management component 400, in accordance with various aspects and embodiments of the disclosed subject matter. The credit management component 400 can be part of or associated with an open credit exchange platform, for example.

The credit management component 400 can comprise a communication component 402 that can communicate (e.g., transmit, receive) information, including financial-related information associated with users (e.g., consumers), information relating to approved financial offers, and/or other information, between the credit management component 400 and other components or devices, such as communication devices associated with users, financial service providers, and/or financial information providers. The communicator component 402 can employ one or more communication protocols to facilitate controlling data or voice flows, and/or wireless or wireline communication of traffic (e.g., voice or data traffic), associated with the credit management component 400.

The credit management component 400 can include an interface component 404 that can comprise one or more interfaces, including one or more controls, switches, adapters, connectors, buttons, routers, speakers, display screens, GUIs, and/or touch screen GUIs, etc., that can facilitate enabling the credit management component 400 to interface and/or communicate with other systems, components, or devices (e.g., communication devices associated with consumers, financial service providers, or financial information providers; systems, components, or devices associated with a communication network(s); etc.), or users (e.g., administrators, engineers, technicians, etc.) associated with the open credit exchange platform. The interface component 404 can facilitate establishing a communication channel (e.g., a secure wireless or wireline communication channel) between the credit management component 400 and a communication device (e.g., of a consumer, financial service provider, financial information provider, etc.) associated with the open credit management platform.

The credit management component 400 can comprise a monitor component 406 that can monitor (e.g., continuously, periodically, dynamically (e.g., in response to a condition for monitoring information being met), etc.) information in real or near real time. The monitor component 406 can monitor, for example, financial-related information associated with respective consumers (e.g., as directly obtained by the credit management component 400, as obtained from financial service providers, as obtained from financial information providers, as provided by consumers, etc.), approved financial offers being provided by communication devices associated with financial service providers, outstanding debts associated with respective consumers, user preferences, etc.

The credit management component 400 also can contain an aggregator component 408 that can aggregate or collect the information (e.g., financial-related information, approved financial offers, user preferences, etc.). For instance, the aggregator component 408 can aggregate information received (e.g., obtained) from various entities (e.g., monitor component 406 or another component(s) of the credit management component 400, communication network, an application (e.g., a financial application, which can be a mobile or web application), a server or other communication device, processor, data store, etc.). The aggregator component 408 can correlate respective items of data based at least in part on type of data (e.g., information relating to a particular financial transaction, information relating to a particular financial offer, metadata, etc.), a consumer to which the data relates, source of the data, time or date the data was generated or received, etc., to facilitate analyzing or evaluating of the data by the analyzer component 410 or another component of the credit management component 400.

The analyzer component 410 can analyze, evaluate, and/or parse information (e.g., financial-related information, approved financial offers, user preferences, etc.) to facilitate identifying one or more desirable (e.g., a best or most preferred, or a subset of best or most preferred) approved financial offers, identifying or standardizing respective financial-related parameters or factors (e.g., N financial-related parameters or factors), synthesizing various pieces of information (e.g., financial-related information or other information associated with a consumer) to generate a financial-related parameter(s) or factor(s), adjusting a user profile relating to a user (e.g., consumer, financial service provider, etc.), verifying an electronic signature of a consumer, determining whether to refinance a loan or consolidate a plurality of loans and/or credit account balances, etc. The analyzer component 410 can generate analysis results based at least in part on the analyzing, evaluating, and/or parsing of such information, and can provide the analysis results to another component(s) (e.g., offer management component 412, refinance management component 414, classifier component 422, etc.) for further processing.

The credit management component 400 can comprise an offer management component 412 that can evaluate approved financial offers directed to a consumer and received from respective financial service providers. Based at least in part on the results of the evaluation, the offer management component 412 can identify and select (e.g., automatically or dynamically identify and select) one or more desirable (e.g., a best or most preferred, or a subset of best or most preferred) approved financial offers, in accordance with the defined financial offer criteria. The credit management component 400, using the communication component 402 and/or another component(s) (e.g., notification component 428), can facilitate communicating the one or more desirable approved financial offers to a communication device associated with the consumer.

The credit management component 400 also can include a refinance management component 414 that can monitor and evaluate open loans, credit accounts, etc., associated with a consumer to facilitate determining whether to refinance (e.g., automatically refinance) a loan associated with the consumer, or refinance and consolidate a plurality of loans and/or credit account balances associated with the consumer to a new loan. Based at least in part on the results of the evaluation, the refinance management component 414 can determine (e.g., automatically or dynamically determine) whether to refinance a loan, or refinance and consolidate a plurality of loans and/or credit account balances to a new loan, in accordance with the defined financial offer criteria. For example, the refinance management component 414 can evaluate two loan balances having respective interest rates, and can evaluate approved loan offers (e.g., approved refinance loan offers) available to the consumer, to facilitate determining whether it is desirable (e.g., proper, beneficial, etc.) to refinance the two loans balances through a new approved loan based on an approved loan offer, in accordance with the defined financial offer criteria and/or user preferences of the potential offeree. If the refinance management component 414 determines that refinancing the two loan balances through a new approved loan meets the defined financial offer criteria and/or the user preferences, the refinance management component 414 can refinance automatically or dynamically, or in response to a consumer's instruction to accept the approved financial offer) the two loan balances to generate a new approved loan associated with the user.

The credit management component 400 also can contain a user data management component 416 that can collect, manage, and secure data associated with users (e.g., consumers, financial service providers, financial information providers, etc.) who are associated with (e.g., registered with, affiliated with, using, etc.) the open credit exchange platform. The user data management component 416 can make available financial-related information or other information to entities, such as the financial service providers, associated with the open credit exchange platform to facilitate enabling the financial service providers to accurately evaluate (e.g., estimate or score) the financial risk of making an approved financial offer to a consumer.

In some implementations, the user data management component 416 can control what information associated with consumers is exposed to financial service providers, for example, based at least in part on defined security criteria and/or user preferences of the consumer. The user data management component 416 can provide a desired level of anonymity to users (e.g., consumers) to hide or obscure a user's actual name or other user information from other entities (e.g., financial service providers) associated with the open credit exchange platform. For example, the user data management component 416 can generate (e.g., randomly generate) a pseudo ID name or number for a consumer that can be provided to other entities associated with the open credit exchange platform, instead of providing the consumer's actual name as an ID to the other entities.

The credit management component 400 also can include a security component 418 that can secure data associated with the open credit exchange platform and also can operate in conjunction with the user data management component 416 to facilitate securing such data. The security component 418 can operate in conjunction with the communication component 402 to establish a secure communication channel between the open credit exchange platform and communication devices associated with users (e.g., consumers, financial service providers, financial information providers, etc.), in accordance with a defined security protocol(s) and defined security criteria. For example, the security component 418 can establish a secure communication channel in accordance with a SSL protocol and/or other cryptographic protocol. The security component 418 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, PKI, DSS, DES, triple-DES, AES, cryptographic hash functions, etc.).

The security component 418 also can utilize identification and/or authentication procedures to identify and/or authenticate communication devices and associated users attempting to access the open credit exchange platform. For example, the security component 418 can control access to the open credit exchange platform based at least in part on verification of authentication credentials provided by communication devices of users. The security component 418 can grant certain access rights to a communication device of a user in response to verifying the authentication credentials presented by the communication device, wherein the access rights granted can be based at least in part on the particular user (e.g., type of user, such as consumer, financial service provider, financial information provider, etc.), the authentication credentials presented, and/or defined security criteria. For example, in accordance with the defined security criteria, the security component 418 can grant a consumer (and associated communication device) registered with the open credit exchange platform a first subset of access rights to the open credit exchange platform, and grant a financial service provider (and associated communication device) registered with the open credit exchange platform a second subset of access rights to the open credit exchange platform. Identification information (e.g., identification information that can identify a communication device or associated user) and/or authentication credentials can include or be based at least in part on, for example, a username, a password, a personal identification number (PIN), biometric information (e.g., fingerprint information, eye or iris related information, facial recognition related information, etc.) associated with a user, a communication device identifier (e.g., media access control (MAC) address, an identifier associated with a subscriber identity module (SIM) card, etc.) associated with a communication device, an authentication-related key (e.g., key associated with a SIM card), etc.

The security component 418 also can operate in conjunction with the user data management component 416 to facilitate generating (e.g., randomly generating) a pseudo ID name or number for a consumer that can be provided to other entities associated with the open credit exchange platform, instead of providing the consumer's actual name as an ID to the other entities. In some implementations, the security component 418 can use a random number generator component that can generate random or pseudo-random numbers that can be used to facilitate generating a pseudo ID name or number for a consumer.

The credit management component 400 can further include a data verification component 420 that can verify and/or identify confidence levels (e.g., accuracy, authenticity, trust, etc., levels) of respective pieces of data. In some implementations, the data verification component 420 can operate in conjunction with or can be part of the user data management component 416 to facilitate identifying the reliability of the data (e.g., accuracy, authenticity, trustworthiness, etc., of the data) collected and managed by the user data management component.

The data verification component 420 can evaluate a piece of data, metadata associated with the piece of data, the type of data the piece of data is, the source of the piece of data, the age of the piece of data, other data potentially relevant to the piece of data (e.g., other data that can or may corroborate the accuracy, authenticity, trustworthiness, etc., of the piece of data), and/or other factors, and can verify the piece of data or identify a confidence level to assign the piece of data based at least in part on the evaluation. For example, the data verification component 420 can identify a piece of data as having a high level of accuracy and trustworthiness based at least in part on identifying that the piece of data is from a reputable source and/or the accuracy and trustworthiness of the information in the piece of data is corroborated by other data. The data verification component 420 can identify another piece of data as having a relatively low level of accuracy or trustworthiness based at least in part on identifying that this other piece of data is from a non-reputable or biased source (e.g., a consumer's job income as stated by the consumer) and/or the accuracy and trustworthiness of the information in the piece of data is not corroborated by other data (e.g., the consumer's job income, as stated by the consumer, is not corroborated or supported by other data evidencing that the consumer's job income is as the consumer stated). The data verification component 420 can assign a confidence level ranging, for example, from 0% (e.g., unverified or completely inaccurate) to 100% (e.g., completely accurate and/or verified), from low(est) confidence level (e.g., unverified or completely inaccurate) to high(est) confidence level (e.g., completely accurate and/or verified), and/or other types of confidence levels (e.g., respective color coding of respective confidence levels, such as, for example, green color to indicate verified and/or accurate data, yellow color to indicate a lower confidence level in the accuracy or trustworthiness of the data, and red color to indicate the lowest confidence level in the accuracy or trustworthiness of the data and/or to indicate that the data has not yet been evaluated for verification).

The credit management component 400 also can comprise a classifier component 422 that can classify or standardize financial products (e.g., approved financial offers) to facilitate enabling a user to do an informed comparison of the respective financial products (e.g., do an apples-to-apples comparison, instead of an apple-to-oranges comparison. For example, the classifier component 422 can take a first approved financial offer having a first set of financial terms or conditions and a second approved financial offer having a second set of financial terms or conditions, and can synthesize the information associated with the first and second approved financial offers to present them to the user in a way so as to facilitate enabling the user to do an informed comparison of the respective approved financial offers. For instance, the classifier component 422 can identify pertinent factors (e.g., monthly payment, number of months for repayment, effective interest rate, total repayment amount, etc.) for each of the first and second approved financial offers, and can present this information to the communication device of the user for comparison.

The credit management component 400 can further contain a financial account component 424 that can facilitate maintaining respective account information (e.g., financial account information, such as account number, outstanding balance, payment history, monthly payment amount, interest rate, etc.) of respective users (e.g., consumers, financial service providers, etc.), depositing funds to or withdrawing funds from a financial account of a user, transferring funds from one financial account to another financial account, adjusting a credit line or financial terms associated with a financial account, etc. For example, the financial account component 424 (e.g., operating in conjunction with the refinance management component 414 or other component) can facilitate generating a new financial account in relation to a refinance loan and can transfer outstanding balances of one or more financial accounts to the new financial account and/or close the one or more financial accounts after the transfer.

The financial account component 424 also can facilitate enabling a user to view and manage a digital wallet associated with the user's financial accounts recognized or maintained by the open credit exchange platform. For example, a user can use a communication device (e.g., via the financial application) to access, view, and/or manage the user's digital wallet and associated financial accounts, wherein the user can view a status (e.g., outstanding balance, payment status, etc.) or other information associated with a financial account, make payments on a financial account associated with the digital wallet, withdraw funds from or deposit funds to a financial account associated with the digital wallet, modify information associated with a financial account, etc.

The credit management component 400 also can comprise a mapper component 426 that can generate a mapping (e.g., in real or near real time) of an item(s) of data to another item(s) of data to facilitate enabling approved financial offers to be identified and provided to consumers. For example, the mapper component 426 can generate a mapping of consumer parameters (e.g., credit history of a consumer, current income of a consumer, current outstanding debt of a consumer, current debt-to-income ratio of the consumer, consumer behavior, current potential financial transaction of a consumer, etc.) identified for respective consumers to a set of approved financial offers (e.g., in relation to financial transactions) from respective financial service providers to facilitate identifying one or more approved financial offers for presentation to a consumer via the consumer's communication device. In some implementations, the mapper component 426 can generate a mapping of approved financial offers (e.g., generic approved financial offers not expressly directed to a consumer by a financial service provider) to consumers, based at least in part on the consumer parameters. For example, a financial service provider can provide, via a communication device, an approved financial offer, which is not specifically directed to a consumer by the financial service provider, to the open credit exchange platform, wherein the approved financial offer can have a set of qualifications for a consumer to be pre-approved to accept the approved financial offer. The mapper component 426 and/or another component(s) (e.g., analyzer component 410) of the credit management component 400 can evaluate the set of qualifications associated with the approved financial offer and respective consumer parameters of consumers, can identify one or more consumers who qualify for the approved financial offer, and can generate a mapping between the approved financial offer and the one or more qualifying consumers. The credit management component 400 can utilize this mapping to facilitate determining whether to present a consumer with the approved financial offer and/or notifying a financial service provider of consumers who meet the set of qualifications, wherein the financial service provider can determine whether to extend the approved financial offer to the one or more of the qualifying consumers.

The credit management component 400 can comprise a notification component 428 that can generate notifications relating to approved financial offers to facilitate notifying consumers of the approved financial offers. For instance, the notification component 428 can generate a notification of an approved financial offer (e.g., a best or most preferred approved financial offer) for a consumer, and the credit management component 400 (e.g., using the communication component 402) can transmit this notification to a communication device associated with that consumer. The notification component 428 also can generate other types of notifications to facilitate providing information relating to a consumer's finances to the communication device associated with the consumer. For example, the notification component 428 can generate a notification relating to the financial health of a consumer (e.g., notification relating to the status of consumer's financial health, a change in the status of the consumer's financial health or strength, an automatic refinance of an account(s) or loan(s) of the consumer, etc.) or a notification relating to an action(s) a consumer can take to facilitate improving the consumer's financial health or strength. The notification component 428 also can generate a notification relating to selection of an approved financial offer made by a financial service provider. For example, the notification component 428 can generate a notification that the credit management component 400 selected an approved financial offer made by a financial service provider or a notification that a consumer accepted the approved financial offer, and the credit management component 400 can transmit such notification(s) to a communication device associated with the financial service provider to notify the financial service provider that the approved financial offer was selected or accepted.

The credit management component 400 also can contain a signature component 430 that can verify or authenticate an electronic signature of a user(s) (e.g., consumer, financial service provider, etc.) in relation to a contract (e.g., an electronic document that includes a contract) between a consumer and a financial service provider relating to an approved financial offer by the financial service provider to the consumer. The signature component 430 (e.g., operating in conjunction with the security component 418) can evaluate an electronic signature provided by a user and can determine whether the electronic signature provided by the user is valid or verified, in accordance with the defined security criteria. If the signature component 430 verifies an electronic signature of a consumer on a contract relating to an approved financial offer, for example, a legally binding contract can be created, and the financial benefits (e.g., monetary funds, credit line, etc.) associated with the approved financial offer can be provided (e.g., deposited) to a financial account of the consumer or applied to a financial transaction being made by the consumer.

The credit management component 400 can include a registration component 432 that can register users (e.g., consumers, financial service providers, financial information providers, etc.), with the open credit exchange platform. The registration component 432 can receive information from a communication device of a user or can generate information to facilitate registering users and/or generating authentication credentials for users to use when attempting to access the open credit exchange platform. For example, the registration component 432 can receive a user's (e.g., consumer's) personal information (e.g., name, address, phone number, etc.), job history, financial information associated with the user (e.g., income history, bank or credit account information, loan information, etc.), to facilitate registering the user with the open credit exchange platform. The registration component 432 also can receive information relating to authentication credentials from the user to facilitate generating authentication credentials for the user and/or can generate authentication credentials that can be assigned to the user. The registration component 432 also can register other types of users, such as financial service providers, financial information providers, etc., with the open credit exchange platform, wherein the registration component 432 can receive or generate respective items of information associated with respective users to facilitate registering the respective users with the open credit exchange platform and/or generating or assigning respective authentication credentials to the respective users. For each of the respective users, the registration component 432 can generate a user profile and can store information associated with the user in the user profile of the user, wherein the registration component 432 can store user profiles in the data store 440.

The credit management component 400 can further comprise an application component 434 that can generate, update, and/or use one or more applications to facilitate operation of the open credit exchange platform, access or use of the open credit exchange platform by communication devices of users. In some implementations, the application component 434 or another component of the credit management component 400 can provide respective applications (e.g., financial applications) to respective communication devices of respective users, wherein the communication devices can use the respective applications to facilitate accessing and using the open credit exchange platform. The application (e.g., consumer financial application) used for a communication device associated with one type of user (e.g., consumer) can be the same as or different from an application (e.g., FSP financial application) used for a communication device associated with another type of user (e.g., financial service provider, and/or an application used for one type of communication device (e.g., desktop computer) can be the same as or different from an application (e.g., mobile application) used for another type of communication device (e.g., mobile phone, electronic pad or tablet).

The credit management component 400 also can include an instruction component 436 that can evaluate information (e.g., financial information, such as, for example, credit history, consumer behavior, current income, current debt obligations, current financial strength or health, etc.) of the consumer to identify one or more recommended actions that the consumer can or may take to facilitate improving the consumer's financial strength or health. A recommended action can include information relating to the type(s) of action(s) or step(s) the consumer can take, a reason(s) why the recommended action can be beneficial to the consumer, an expected or estimated value of the benefit that can be obtained by the recommended action, or other information. The instruction component 436 (e.g., via the communication component 402) can provide the one or more recommended actions to the consumer via the consumer's communication device.

The credit management component 400 also can comprise a processor component 438 that can work in conjunction with the other components (e.g., communication component 402, interface component 404, monitor component 406, etc.) to facilitate performing the various functions of the credit management component 400. The processor component 438 can employ one or more processors, microprocessors, or controllers that can process data, such as information (e.g., financial-related information) relating to users associated with the open credit exchange platform, information relating to cryptography or authentication (e.g., information relating to defined security, cryptographic, and/or authentication protocols), information relating to other operations of the credit management component 400, and/or other information, etc., to facilitate operation of the credit management component 400, as more fully disclosed herein, and control data flow between the credit management component 400 and other components (e.g., other components of or associated with the credit management component 400).

The credit management component 400 also can include a data store 440 that can store data structures (e.g., user data, metadata), code structure(s) (e.g., modules, objects, hashes, classes, procedures) or instructions, information (e.g., financial-related information) relating to users associated with the open credit exchange platform, information relating to cryptography or authentication (e.g., information relating to defined security, cryptographic, and/or authentication protocols), information relating to other operations of the credit management component 400, and/or other information, etc., to facilitate controlling operations associated with the credit management component 400. In an aspect, the processor component 438 can be functionally coupled (e.g., through a memory bus) to the data store 440 in order to store and retrieve information desired to operate and/or confer functionality, at least in part, to the communication component 402, interface component 404, monitor component 406, etc., and/or substantially any other operational aspects of the credit management component 400.

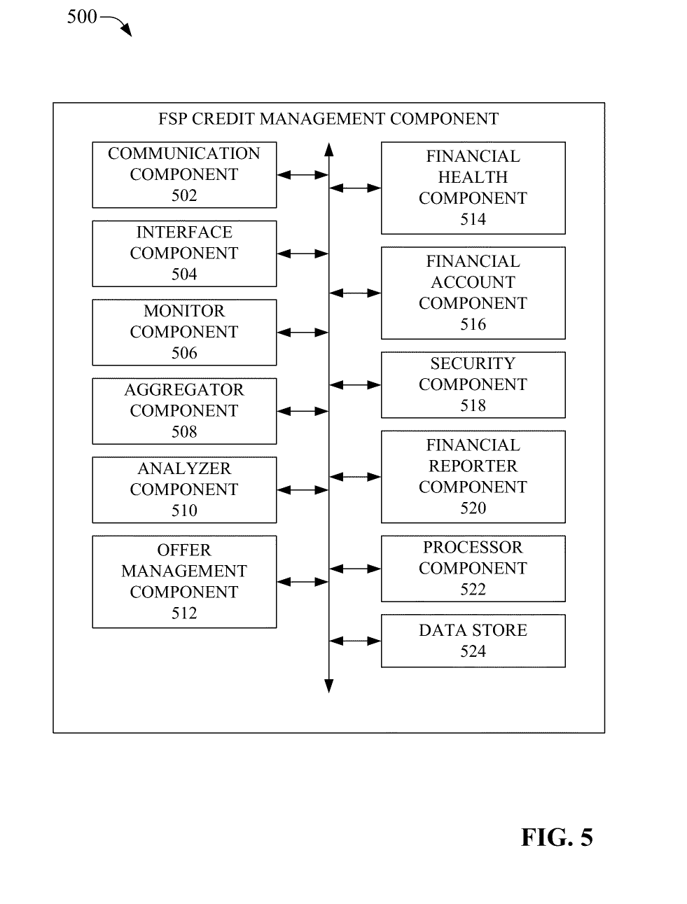

FIG. 5 illustrates a block diagram of an example FSP credit management component 500, in accordance with various aspects and embodiments of the disclosed subject matter. The FSP credit management component 500 can be associated with (e.g., communicatively connected to) an open credit exchange platform and/or communication devices associated with consumers, for example. The FSP credit management component 500 can be associated with, managed, operated, and/or utilized by a financial service provider.

The FSP credit management component 500 can comprise a communication component 502 that can communicate (e.g., transmit, receive) information, including financial-related information associated with the financial service provider and/or users (e.g., consumers), information relating to approved financial offers, and/or other information, between the FSP credit management component 500 and other components or devices, such as the open credit management platform (e.g., a communication device of or associated with the open credit management platform), communication devices associated with other financial service providers, communication devices associated with financial information providers, and/or communication devices associated with users. The communication component 502 can employ one or more communication protocols to facilitate controlling data or voice flows, and/or wireless or wireline communication of traffic (e.g., voice or data traffic), associated with the FSP credit management component 500.

The FSP credit management component 500 can include an interface component 504 that can comprise one or more interfaces, including one or more controls, switches, adapters, connectors, buttons, routers, speakers, display screens, GUIs, and/or touch screen GUIs, etc., that can facilitate enabling the FSP credit management component 500 to interface and/or communicate with other systems, components, or devices (e.g., open credit management platform; communication devices associated with consumers, financial service providers, or financial information providers; systems, components, or devices associated with a communication network(s); etc.), or users (e.g., system administrators, engineers, technicians, etc.) associated with the FSP credit management component 500 and/or the associated financial service provider. The interface component 504 can facilitate establishing a communication channel (e.g., a secure wireless or wireline communication channel) between the FSP credit management component 500 and the open credit management platform or a communication device associated with a consumer, another financial service provider, financial information provider, etc.

The FSP credit management component 500 can comprise a monitor component 506 that can monitor (e.g., continuously, periodically, dynamically (e.g., in response to a condition for monitoring information being met), etc.) information in real or near real time. The monitor component 506 can monitor, for example, financial-related information associated with respective consumers (e.g., as obtained from the open credit exchange platform, as directly obtained by the FSP credit management component 500, as obtained from communication devices of other financial service providers, as obtained from communication devices of financial information providers, as obtained from consumers (e.g., via communication devices of consumers), etc.). For instance, the open credit exchange platform can provide or make available the defined N financial-related parameters relating to one or more consumers to facilitate evaluation of financial-related information of the one or more consumers by the financial service provider(s). The monitor component 506 can monitor the financial-related parameters to facilitate updating the financial-related information of the one or more consumers in the data store 524, identifying a financial health or strength of a consumer, identifying an approved financial offer to be presented to a consumer, etc.

The FSP credit management component 500 also can contain an aggregator component 508 that can aggregate or collect the information (e.g., financial-related information, approved financial offers, consumer financial history, consumer preferences, etc.). For instance, the aggregator component 508 can aggregate information received (e.g., obtained) from various entities (e.g., open credit exchange platform, monitor component 506 or another component(s) of the FSP credit management component 500, communication network, an application (e.g., a mobile or web application), a server or other communication device, processor, data store, etc.). The aggregator component 508 can correlate respective items of data based at least in part on type of data (e.g., information relating to a particular financial transaction, information relating to a particular financial offer, metadata, etc.), consumer to which the data relates, source of the data, time or date the data was generated or received, etc., to facilitate analyzing or evaluating of the data by the analyzer component 510 or another component of the FSP credit management component 500.

The analyzer component 510 can analyze, evaluate, and/or parse information (e.g., financial-related information, defined financial assessment criteria, etc.) to facilitate identifying a financial health or strength of a consumer, identifying an approved financial offer to be presented to a consumer, modifying (e.g., updating) a user profile relating to a user (e.g., consumer), etc. The analyzer component 510 can generate analysis results based at least in part on the analyzing, evaluating, and/or parsing of such information, and can provide the analysis results to another component(s) (e.g., offer management component 512, processor component 522, data store 524, etc.) for further processing.

The FSP credit management component 500 can comprise an offer management component 512 that, for respective consumers, can identify or evaluate financial-related information and/or the financial health associated with a consumer, and can identify one or more approved financial offers that can be directed to the consumer, based at least in part on the financial-related information and/or the financial health associated with the consumer. For instance, the offer management component 512 can receive the analysis results from the analyzer component 510, and can evaluate the analysis results. The offer management component 512 can identify and select (e.g., automatically or dynamically identify and select) the one or more approved financial offers that can be made to the consumer, based at least in part on the evaluation of the analysis results, in accordance with the defined financial assessment criteria associated with the financial service provider. The offer management component 512 also can generate contracts, comprising the contract terms, associated with the approved financial offers, wherein a contract can be provided or presented (e.g., by the FSP credit management component 500 or the open credit exchange platform) with an approved financial offer or in response to acceptance of the approved financial offer by the consumer. The FSP credit management component 500, using the communication component 502 and/or another component(s), can facilitate communicating the one or more approved financial offers to, for example, the open credit exchange platform.

The FSP credit management component 500 also can include a financial health component 514 that, for respective consumers, can identify a financial health or strength of a consumer. The financial health component 514 can identify the financial health or strength of a consumer, based at least in part on its own analysis or evaluation of financial-related information associated with a consumer (or that of another component (e.g., the analyzer component 510) of the FSP credit management component 500), a financial health or strength assessment or score from the open credit exchange platform, and/or a financial health or strength assessment or score from another entity (e.g., a financial information provider).

The FSP credit management component 500 also can contain a financial account component 516 that can collect, manage, and secure data (e.g., financial-related information) associated with consumers who are associated with (e.g., registered with, engaged in business with, potentially engaged in business with, etc.) the financial service provider associated with the FSP credit management component 500. For instance, the financial account component 516 can facilitate maintaining respective account information (e.g., financial account information, such as account number, outstanding balance, payment history, monthly payment amount, interest rate, etc.) of respective users (e.g., consumers), applying monetary payments to or withdrawing monetary funds from a financial account of a user (e.g., in accordance with an accepted approved financial offer), adjusting a credit line or financial terms associated with a financial account of a user, etc. The financial account component 516 can create and manage respective user profiles or accounts for respective consumers, and the respective user profiled or accounts can be stored in the data store 524.

The FSP credit management component 500 also can include a security component 518 that can secure data associated with the FSP credit management component 500. The security component 518 can operate in conjunction with the communication component 502 to establish a secure communication channel between the FSP credit management component 500 and the open credit exchange platform or communication devices associated with users (e.g., consumers, financial service providers, financial information providers, etc.), in accordance with a defined security protocol(s) and defined security criteria. For example, the security component 518 can establish a secure communication channel in accordance with an SSL protocol and/or other cryptographic protocol. The security component 518 can encrypt data that is to be transmitted to a communication device, and can decrypt encrypted data received from a communication device, in accordance with an appropriate cryptographic protocol(s) (e.g., a protocol(s) relating to data encryption and decryption, public key cryptography, symmetric key, PKI, DSS, DES, triple-DES, AES, cryptographic hash functions, etc.).

The security component 518 also can utilize authentication protocols to authenticate communication devices and associated users attempting to access the FSP credit management component 500. For example, the security component 518 can control access to the FSP credit management component 500 based at least in part on verification of authentication credentials provided by communication devices of the open credit exchange platform and/or users. The security component 518 can grant certain access rights to a communication device of a user in response to verifying the authentication credentials presented by the communication device of the user, wherein the access rights granted can be based at least in part on the particular user (e.g., type of user, such as a user associated with the open credit management platform, a consumer, a financial service provider, a financial information provider, etc.), the authentication credentials presented, and/or the defined security criteria. For example, in accordance with the defined security criteria, the security component 518 can grant a consumer (and associated communication device), who is registered with the FSP credit management component 500, a first subset of access rights to the FSP credit management component 500, and grant a user, who is associated with the open credit exchange platform (and associated communication device) that is associated with the FSP credit management component 500, a second subset of access rights to the FSP credit management component 500. Authentication credentials can include or be based at least in part on, for example, a username, a password, a PIN, biometric information (e.g., fingerprint information, eye or iris related information, facial recognition related information, etc.) associated with a user, a communication device identifier (e.g., MAC address) associated with a communication device, etc. In some implementations, the security component 518 can use a random or pseudo-random number generator component that can generate (e.g., randomly or pseudo-randomly generate) random or pseudo-random numbers, which can be used to facilitate securing data, in accordance with the defined security criteria.

The FSP credit management component 500 can contain a financial reporter component 520 that can facilitate reporting of information (e.g., financial-related information) to the open credit exchange platform or another component(s) (e.g., communication device associated with a financial service provider, financial information provider, or other entity) associated with the FSP credit management component 500. For instance, the financial reporter component 520 can provide and/or update information relating to a consumer to the open credit exchange platform to facilitate enabling the open credit exchange platform to identify or update financial-related information relating to the consumer, identify or update a financial health or strength of the consumer, identify or update information relating to a financial account of the consumer, etc.

The FSP credit management component 500 also can comprise a processor component 522 that can work in conjunction with the other components (e.g., communication component 502, interface component 504, monitor component 506, etc.) to facilitate performing the various functions of the FSP credit management component 500. The processor component 522 can employ one or more processors, microprocessors, or controllers that can process data, such as information (e.g., financial-related information) relating to users associated with the FSP credit management component 500, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 500, and/or other information, etc., to facilitate operation of the FSP credit management component 500, as more fully disclosed herein, and control data flow between the FSP credit management component 500 and other components (e.g., other components of or associated with the FSP credit management component 500).

The FSP credit management component 500 also can include a data store 524 that can store data structures (e.g., user data, metadata), code structure(s) (e.g., modules, objects, hashes, classes, procedures) or instructions, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 500, and/or other information, etc., to facilitate controlling operations associated with the FSP credit management component 500. In an aspect, the processor component 522 can be functionally coupled (e.g., through a memory bus) to the data store 524 in order to store and retrieve information desired to operate and/or confer functionality, at least in part, to the communication component 502, interface component 504, monitor component 506, etc., and/or substantially any other operational aspects of the FSP credit management component 500.

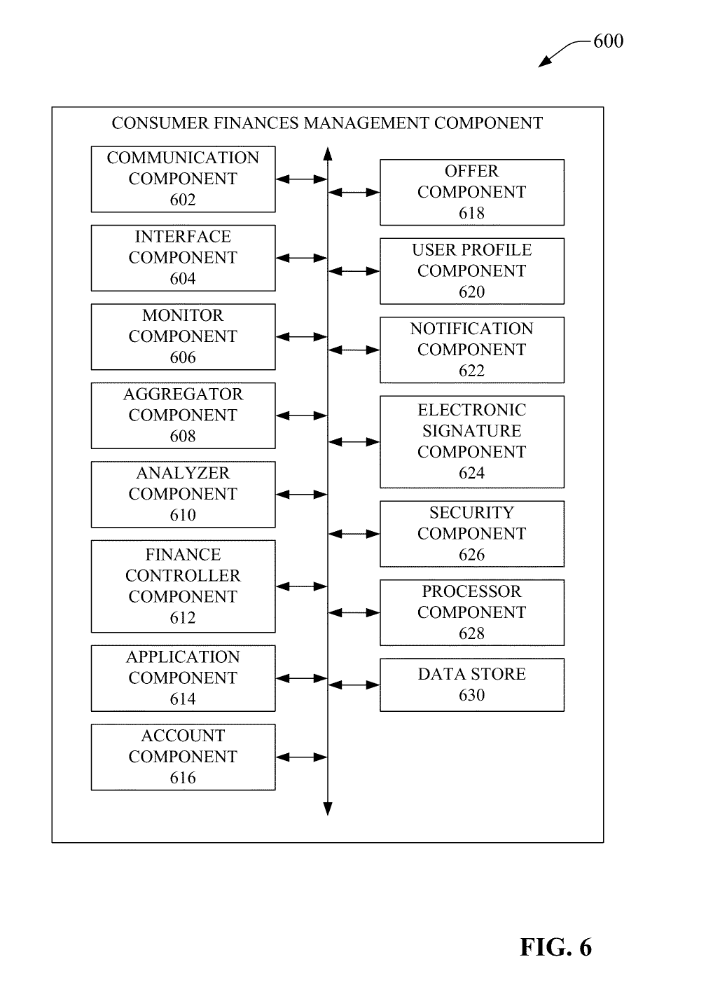

FIG. 6 depicts a block diagram of an example consumer finances management component 600, in accordance with various aspects and embodiments of the disclosed subject matter. The consumer finances management component 600 can be part of or associated with a communication device (e.g., mobile phone, computer, etc.) associated with a user (e.g., consumer). In some implementations, various aspects or functions of the consumer finances management component 600 can be facilitated using an application (e.g., a locally based or mobile application, a web based application).

The consumer finances management component 600 can comprise a communication component 602 that can communicate (e.g., transmit, receive) information, including financial-related information associated with a user (e.g., consumer), information relating to approved financial offers or associated contracts, and/or other information, between the consumer finances management component 600 and other components or devices, such as the open credit management platform (e.g., a communication device of or associated with the open credit management platform), communication devices associated with financial service providers, and/or communication devices associated with financial information providers. The communicator component 602 can employ one or more communication protocols to facilitate controlling data or voice flows, and/or wireless or wireline communication of traffic (e.g., voice or data traffic), associated with the consumer finances management component 600.

The consumer finances management component 600 can include an interface component 604 that can comprise one or more interfaces, including one or more controls, switches, adapters, connectors, buttons, routers, speakers, display screens, GUIs, and/or touch screen GUIs, etc., that can facilitate enabling the consumer finances management component 600 to interface and/or communicate with other systems, components, or devices (e.g., open credit management platform; communication devices associated with financial service providers or financial information providers; systems, components, or devices associated with a communication network(s); etc.). The interface component 604 can facilitate establishing a communication channel (e.g., a secure wireless or wireline communication channel) between the consumer finances management component 600 and the open credit management platform or a communication device associated with a financial service provider, financial information provider, etc.

The consumer finances management component 600 can comprise a monitor component 606 that can monitor (e.g., continuously, periodically, dynamically (e.g., in response to a condition for monitoring information being met)) information in real or near real time. The monitor component 606 can monitor information communications to facilitate detecting and identifying, for example, financial-related information, including approved financial offers, contracts relating to approved financial offers, notifications relating to approved financial offers, notifications relating to refinancing of a financial account(s) or debt(s) of a user of the communication device, notifications relating to financial strength or health of the user, etc. For instance, the monitor component 606 can be monitoring information communications associated with the communication device, comprising the consumer finances management component 600. The monitor component 606 can identify or detect an approved financial offer being made to the user associated with the communication device or a notification relating to financial-related information associated with the user and can facilitate providing information relating to the approved financial offer or the notification to the user via an interface(s) associated with the interface component 604.

The consumer finances management component 600 also can contain an aggregator component 608 that can aggregate or collect information (e.g., financial-related information, approved financial offers, user preferences, etc.) received or maintained by the communication device. For instance, the aggregator component 608 can aggregate information received (e.g., obtained) from various entities (e.g., open credit exchange platform, monitor component 606 or another component(s) of the consumer finances management component 600, communication network, an application (e.g., a mobile or web application), a server or other communication device, processor, data store, etc.). The aggregator component 608 can correlate respective items of data based at least in part on type of data (e.g., information relating to a particular financial transaction, information relating to a particular approved financial offer, metadata, etc.), source of the data, time or date the data was generated or received, etc., to facilitate analyzing or evaluating of the data by the analyzer component 610 or another component of the consumer finances management component 600.

The analyzer component 610 can analyze, evaluate, and/or parse information (e.g., financial-related information, etc.) associated with the user (e.g., consumer) to facilitate identifying current assets and debts (e.g., identifying total assets and debts, identifying a subset of assets and debts), modifying (e.g., updating) a user profile relating to the user, identifying a financial health or strength of a consumer, etc. The analyzer component 610 can generate analysis results based at least in part on the analyzing, evaluating, and/or parsing of such information, and can provide the analysis results to another component(s) (e.g., finance controller component 612, processor component 628, data store 630, etc.) for further processing.

The consumer finances management component 600 also can comprise a finance controller component 612 that can control operations associated with the various components of the consumer finances management component 600. For instance, the finance controller component 612 can control operations of the consumer finances management component 600 to facilitate identifying and presenting approved financial offers, contracts associated with approved financial offers, electronic signatures relating to such contracts, notifications relating financial-related information, etc., by the consumer finances management component 600 to facilitate presentation of such information to the user of the communication device. The finance controller component 612 also can facilitate controlling data flow between the various components (e.g., communication component 602, interface component 604, monitor component 606, etc.) of the consumer finances management component 600 to facilitate performing the various operations of the consumer finances management component 600.

The consumer finances management component 600 also can include an application component 614 that can comprise an application(s) (e.g., financial application) that can be utilized by the communication device to facilitate interaction (e.g., communication of financial-related information) between the communication device and the open credit exchange platform, financial service providers, financial information providers, etc., creating and maintaining a digital wallet associated with the user of the communication device, executing (e.g., electronic signing and accepting) of contracts relating to approved financial offers, debt monitoring associated with the user, monitoring of financial health or strength associated with the user, monitoring of credit history associated with the user, etc. For instance, the application component 614 can facilitate generating a digital wallet that can aggregate all or a desired portion of financial accounts (e.g., bank accounts, credit accounts, loan accounts, etc.) and available approved financial offers for presentation of information relating to these financial accounts and approved financial offers to the user (e.g., via an interface associated with the application component 614).

The consumer finances management component 600 can comprise an account component 616 that can maintain information relating to the financial accounts and available approved financial offers for presentation of information relating to these financial accounts and approved financial offers. The account component 616 can comprise the digital wallet, for example. The digital wallet can contain and present information relating to the assets and debts of the user, and approved financial offers available to the user. The account component 616 can be generated based at least in part by using an application(s) associated with the application component 614.

The consumer finances management component 600 can contain an offer component 618 that can facilitate managing financial offers, such as approved financial offers, being presented to the user associated with the communication device by the open credit exchange platform and/or a financial service provider. The offer component 618 can provide (e.g., present) the terms (e.g., amount of funds available, interest rate, fee(s), installment payment amount, repayment period, etc.) of an approved financial offer, a contract relating to the approved financial offer, and/or other information relating to the approved financial offer. In some implementations, the offer component 618 can provide the approved financial offers in a standardized format to facilitate making it easier for the user to comprehend the respective terms of approved financial offers and/or making it easier for the user to compare different approved financial offers with each other.

The consumer finances management component 600 can include a user profile component 620 that can be employed to generate a user profile for the user associated with the communication device. The user profile can include financial-related information associated with the user, identifying information associated with the user, user preferences associated with the user, etc. For example, the user profile can include user preferences that can specify criteria (e.g., financial offer related criteria) of the user that can facilitate managing presentation of approved financial offers, refinancing of debts associated with the user, etc. The user profile also can include user preferences relating to privacy or security of information relating to the user. For instance, the user profile component 620 can include user preferences relating to information security that can facilitate controlling what information of the user is exposed to the open credit exchange platform, financial service providers, financial information providers, etc.

The consumer finances management component 600 can comprise a notification component 622 that can facilitate generating and/or presenting of notifications relating to approved financial offers, refinancing of debts (e.g., refinancing of a loan(s)), financial health or strength, improving the financial health or strength, etc., associated with the user. The notification component 622 can receive notification messages from, for example, the open credit exchange platform, wherein the notification messages can notify the user of an approved financial offer being extended to the user by a financial service provider, notify the user of a refinancing of debts of the user (e.g., performed by the open credit exchange platform) or an opportunity to refinance debts of the user, notify the user of a change in the financial health or strength of the user, notify the user of instructions to facilitate improving the financial health or strength of the user, etc. The notification component 622 can generate and present (e.g., via an interface(s) of the user's communication device) a notification or alert signal (e.g., message; audial, visual, or other sensory indicator (e.g., vibration of the user's communication device); etc.), based at least in part on, and in response to, the notification message received from the open credit exchange platform, in accordance, for example, with the user preferences of the user. The notification component 622 can generate respective (e.g., different) types of notifications or alerts based at least in part on the type of notification message received from the open credit exchange platform. For example, the notification component 622 can generate and present a first type of alert (e.g., first type of visual, audial, and/or other sensory alert) for a first type of notification (e.g., a notification relating to an approved financial offer), and a second type of alert (e.g., second type of visual, audial, and/or other sensory alert) for a second type of notification (e.g., a notification relating to a change in the financial health or strength of the user).

The consumer finances management component 600 can contain an electronic signature component 624 that can facilitate enabling the user to electronically sign contracts (e.g., electronic document comprising a contract) relating to approved financial offers that are being accepted by the user and/or other electronic documents for which an electronic signature is desired or required. An electronically signed contract can be a legally binding contract between the user and the financial service provider that made the approved financial offer. In some implementations, the electronic signature component 624 can operate in conjunction with the security component 626 to facilitate applying an electronic signature to an electronic document (e.g., contract) in a secure manner, ensuring that the electronic signature is actually being made by the user or other authorized entity (e.g., using an authentication protocol(s)), etc.

The consumer finances management component 600 can include a security component 626 that can secure data associated with the consumer finances management component 600. In some implementations, the security component 626 can facilitate controlling what information of the user is exposed to the open credit exchange platform, financial service providers, financial information providers, etc., in accordance with user preferences contained in the user profile of the user or dynamically selected user preferences of the user. The security component 626 can operate in conjunction with the communication component 602 to establish a secure communication channel between the communication device and the open credit exchange platform and/or communication devices associated with financial service providers, financial information providers, etc., in accordance with a defined security protocol(s) and defined security criteria. For example, the security component 626 can establish a secure communication channel in accordance with an SSL protocol and/or other cryptographic protocol. The security component 626 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, PKI, DSS, DES, triple-DES, AES, cryptographic hash functions, etc.).

In some implementations, the security component 626 can employ a defined authentication protocol(s) to facilitate authenticating an entity (e.g., a user) attempting to access the application, securing the digital wallet (and information or accounts therein) and authenticating an entity attempting to access the digital wallet, authenticating an entity attempting to apply a digital signature to an electronic document, etc. For example, the security component 626 can control access to the application or digital wallet, and/or control applying of an electronic signature to an electronic document, based at least in part on authentication information (e.g., authentication credentials) received from an entity, in accordance with a defined authentication protocol. If the security component 626 verifies the received authentication information in relation to stored authentication information associated with the entity (e.g., if the received authentication information matches the stored authentication information), the security component 626 can grant a subset of access rights to the application or digital wallet to the entity, or apply an electronic signature of the entity to the electronic document, in accordance with the defined authentication protocol. If the security component 626 is not able to verify the received authentication information in relation to the stored authentication information associated with the entity (e.g., if the received authentication information does not match the stored authentication information), the security component 626 can deny access rights to the application or digital wallet to the entity, or can deny application of an electronic signature of the entity to the electronic document, in accordance with the defined authentication protocol.

The consumer finances management component 600 also can comprise a processor component 628 that can work in conjunction with the other components (e.g., communication component 602, interface component 604, monitor component 606, etc.) to facilitate performing the various functions of the consumer finances management component 600. The processor component 628 can employ one or more processors, microprocessors, or controllers that can process data, such as information (e.g., financial-related information) relating to a user(s) associated with the consumer finances management component 600, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 600, and/or other information, etc., to facilitate operation of the consumer finances management component 600, as more fully disclosed herein, and control data flow between the consumer finances management component 600 and other components (e.g., other components of or associated with the consumer finances management component 600).

The consumer finances management component 600 also can include a data store 630 that can store data structures (e.g., user data, metadata), code structure(s) (e.g., modules, objects, hashes, classes, procedures) or instructions, information (e.g., financial-related information) relating to a user(s) associated with the consumer finances management component 600, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 600, and/or other information, etc., to facilitate controlling operations associated with the consumer finances management component 600. In an aspect, the processor component 628 can be functionally coupled (e.g., through a memory bus) to the data store 630 in order to store and retrieve information desired to operate and/or confer functionality, at least in part, to the communication component 602, interface component 604, monitor component 606, etc., and/or substantially any other operational aspects of the consumer finances management component 600.

It is to be appreciated and understood that, in some implementations, respectively named (e.g., same or similarly named) components associated with the financial services component can be shared with the open credit exchange platform. For example, the communicator component, interface component, monitor component, etc., can be shared by both the financial services component and the open credit exchange platform. It also is to be appreciated and understood that, in some implementations, respectively named (e.g., same or similarly named) components associated with a FSP credit management component can be shared with a UFSC associated therewith. For example, the communicator component, interface component, monitor component, etc., can be shared by both the FSP credit management component and the UFSC in connection with a financial service provider. It is to be further appreciated and understood that, in some implementations, respectively named (e.g., same or similarly named) components associated with a consumer finance management component can be shared with a UFSC associated therewith. For example, the communicator component, interface component, monitor component, etc., can be shared by both the consumer finances management component and the UFSC in connection with a user (e.g., consumer).

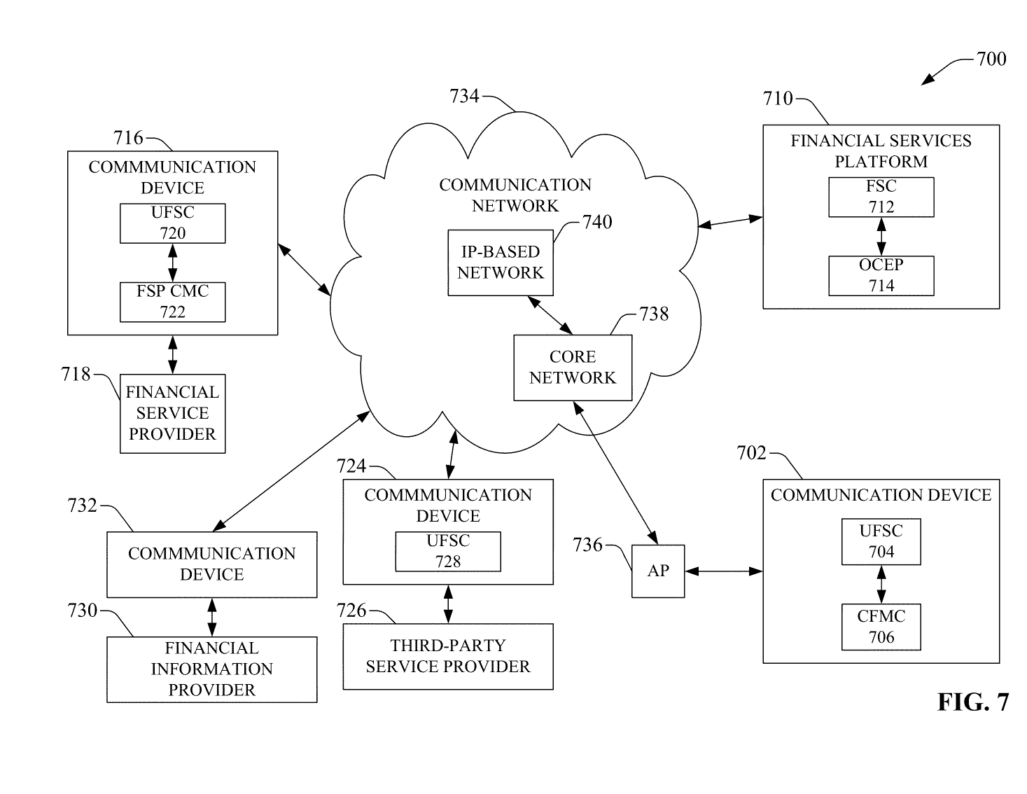

FIG. 7 illustrates a diagram of an example system 700 that can employ a financial services platform to facilitate providing financial services to users via communication devices, in accordance with various aspects and embodiments described herein. In an aspect, the system 700 can include a communication device 702 that can communicate (e.g., voice, data) other communication devices associated with the system 700 in a communication network environment. The communication device 702 can comprise a UFSC 704 that can facilitate managing and using online financial services associated with the user 706 (e.g., consumer) of the communication device 702. The communication device 702 also can include a consumer finances management component 708 (CFMC 708) that can facilitate enabling the user 706 to monitor, manage, execute, etc., financial transactions associated with the user 706, as more fully disclosed herein.

The system 700 can include a financial services platform 710 that can facilitate managing, generating, providing, and using online financial services in a communication network environment. The financial services platform 710 can include a financial services component 712 (FSC 712) that can facilitate controlling the development of online financial services by the financial services component 712, the UFSC 720 associated with a financial service provider 718, the UFSC 728 associated with a third-party service developer 726, and/or the UFSC 704 associated with the user 706. The financial services component 712 also can control the use of online financial services by the user 706, financial service provider 718, and/or third-party service developer 726 via their respective communication devices 702, 716, and/or 724.

The financial services platform 710 also can comprise an open credit exchange platform 714 (OCEP 714) that can manage and process financial transactions associated with consumers and financial service providers, identify and select approved financial offers (e.g., best or most preferred approved financial offer(s)) for presentation to consumers, refinance an account(s) associated with a consumer, collect financial-related information associated with consumers, assess the financial health of a user, make certain financial-related information available to financial service providers, instruct the consumer as to how to improve the consumer's financial health, register users (e.g., consumers, financial service providers, financial information providers, other information providers, etc.) with the open credit exchange platform 706, and/or perform other functions, as more fully disclosed herein. The open credit exchange platform 706 be or can comprise a communication device and can communicate with other communication devices, such as communication device 702, associated with the system 700 in the communication network environment.

The system 700 can include or be associated with a plurality of financial service providers (e.g., financial service provider 718) that can have respective communication devices (e.g., communication device 716) that can be associated with the financial services platform 710 in the communication network environment. The financial service provider(s) 714 can provide financial services (e.g., bank accounts, loans, credit accounts, etc.) to consumers (e.g., user 706). The communication device 716 can include the UFSC 720, which can be used to facilitate managing, developing, and using online financial services and/or finance service modules associated with the financial services platform 710. The communication device 716 also can comprise an FSP credit management component 722 (FSP CMC 722) that can manage financial transactions and financial accounts associated with consumers, evaluate the financial strength and/or creditworthiness of consumers, generate approved financial offers that can be presented to users (e.g., in accordance with the defined financial assessment criteria associated with the financial service provider 718), and/or perform other functions, as more fully disclosed herein.

The system 700 also can comprise or be associated with a plurality of third-party service developers (e.g., third-party service developer 726) that can have respective communication devices (e.g., communication device 724) that can be associated with the financial services platform 710 in the communication network environment. The third-party service developer(s) 726 can manage, develop (e.g., create), and/or use online financial services and finance service modules, which can be used to create online financial services. The communication device 724 can include the UFSC 728, which can be used to facilitate the managing, developing, and using of online financial services and/or finance service modules associated with the financial services platform 710.

The 700 can further comprise one or more financial information providers, including financial information provider 730. The financial information provider(s) 730 can use a communication device(s) 732 to facilitate collecting, analyzing, and/or processing information relating to consumers and/or financial service providers, and can provide that information to other entities, such as the financial services platform 710 (e.g., the open credit exchange platform 714 of the financial services platform 710), consumers (e.g., user 706), financial service providers (e.g., 718), etc.

The system 700 also can include a communication network 734 that can be employed to facilitate communication of voice and data between the communication device 702, the financial services platform 710, communication device 716, communication device 724, communication device 732, or other communication devices associated with the communication network 734. Each of the communication devices (e.g., communication device 702, communication device associated with the financial services platform 710, communication device 716, communication device 724, communication device 732, etc.) can connect to the communication network 734 via a wireline or wireless communication connection. The communication network 734 can comprise or be associated with a number of access points (APs) (e.g., base stations), including AP 736, wherein the AP 736 can facilitate wireless connection of a communication device (e.g., 702) with the communication network 734, when a wireless communication connection is used.

In accordance with various aspects, as a communication device (e.g., 702) is moved through a wireless communication network environment, at various times, the communication device can be connected (e.g., wirelessly connected) to one of a plurality of APs (e.g., macro or cellular AP, femto AP, pico AP, WI-FI AP, WI-MAX AP, etc.), such as the AP 736, that can operate in the wireless communication network environment. An AP (e.g., 736) can serve a specified coverage area to facilitate communication by the communication device or other communication devices in the wireless communication network environment. The AP can serve a respective coverage cell (e.g., macrocell, femtocell, picocell, etc.) that can cover a respective specified area, and the AP can service mobile wireless devices (e.g., communication device 702) located in the respective area covered by the respective cell, where such coverage can be achieved via a wireless link (e.g., uplink (UL), downlink (DL)). When an attachment attempt is successful, the communication device can be served by the AP and incoming voice and data traffic can be paged and routed to the communication device through the AP, and outgoing voice and data traffic from the communication device can be paged and routed through the AP to other communication devices in the communication network environment. In an aspect, the communication device can be connected and can communicate wirelessly using virtually any desired wireless technology, including, for example, cellular, WI-FI, WI-MAX, wireless local area networks (WLAN), etc.

In another aspect, the communication network 734 can comprise a core network 738 (e.g., mobile core network) that can be employed to facilitate communication (e.g., voice, data) by wireless communication devices (e.g., 702) associated (e.g., wirelessly connected) with the core network 738, via the AP 736, and other communication devices (e.g., communication device associated with the financial services platform 710, communication device 716, communication device 724, communication device 732, etc.) associated with the communication network 734. The core network 738 can facilitate routing voice and data communications between wireless communication devices (e.g., 702) and, for example, other communication devices (e.g., communication device associated with the financial services platform 710, communication device 716, communication device 724, communication device 732) associated with an IP-based network 740 (e.g., the Internet)) associated with the communication network 734. The core network 738 also can allocate resources to the a wireless communication device(s) (e.g., 702) associated with the core network 738, convert or enforce protocols, establish and enforce Quality of Service (QoS) for the wireless communication devices, provide applications or services in the network, translate signals, and/or perform other desired functions to facilitate system interoperability and communication in the wireless communication network. The core network 738 further can include desired components, such as routers, nodes, switches, interfaces, controllers, etc., that can facilitate communication of data between communication devices associated with the communication network 734.

The communication network 734 also can include the IP-based network 740 that can be associated with the core network 724 and can facilitate communications by communication devices associated with the communication network 734 at least in part via communication of data packets (e.g., IP-based data packets) between communication devices that are associated with the communication network 734 using a wired or wireless communication connection in accordance with specified IP protocols. The IP-based network 740 further can include desired components, such as routers, nodes, switches, interfaces, controllers, etc., that can facilitate communication of data between communication devices associated with the communication network 734. In an aspect, a wireline communication connection between a communication device (e.g., communication device 702, communication device associated with the financial services platform 710, communication device 716, communication device 724, communication device 732, etc.) and the IP-based network 740 can be a communication connection that can communicate voice or data, and/or can be a DSL-type or broadband connection facilitated via an Ethernet connection, and/or a wireless communication connection can be facilitated via a connection of the wireless communication device (e.g., 702) to an AP (e.g., 736). In accordance with various aspects, a communication device can transmit voice calls or data (e.g., messages) via a wireline or wireless connection through the IP-based network 740, the core network 738, or other communication networks, to another communication device(s) associated with the communication network environment.

In accordance with yet another aspect, the communication device 702 and another communication device (e.g., communication device associated with the financial services platform 710, communication device 716, etc.) can establish a direct communication channel with each other to exchange information, such as information relating to a financial transaction (e.g., purchase of a product or service, transaction relating to an approved financial offer, etc.), using near field communication (NFC) technology or another type of communication technology.

The aforementioned systems and/or devices have been described with respect to interaction between several components. It should be appreciated that such systems and components can include those components or modules specified therein, some of the specified components or modules, and/or additional components. Modules could also be implemented as components communicatively coupled to other components rather than included within parent components. Further yet, one or more components and/or modules may be combined into a single component providing aggregate functionality. The components may also interact with one or more other components not specifically described herein for the sake of brevity, but known by those of skill in the art.

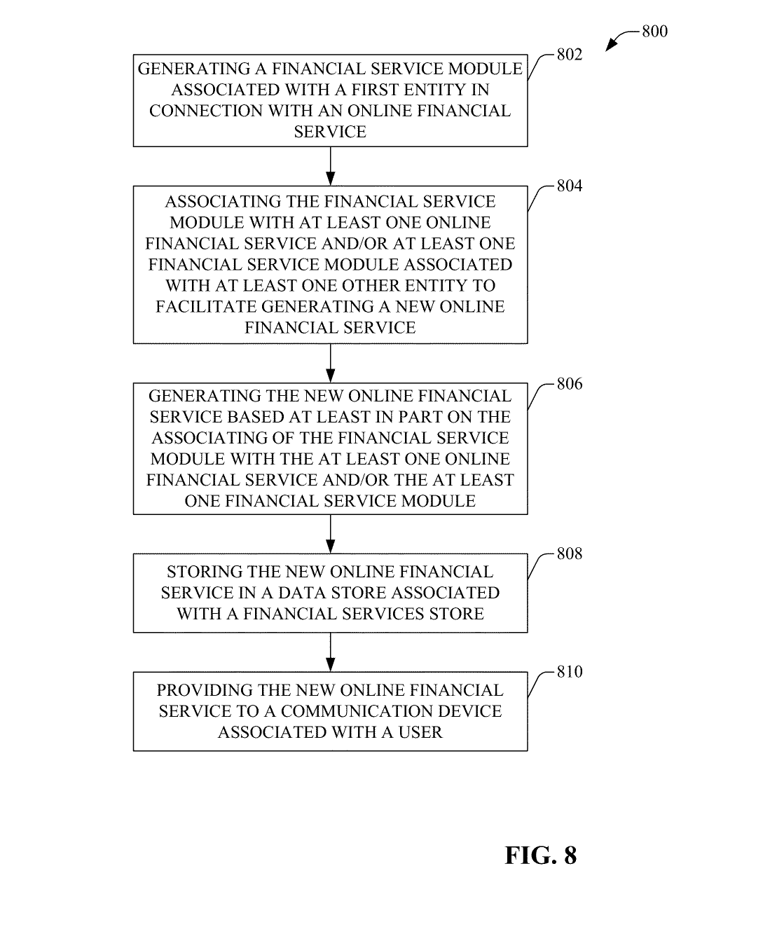

In view of the example systems described above, example methods that can be implemented in accordance with the disclosed subject matter can be better appreciated with reference to flowcharts in FIGS. 8-12. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

Referring to FIG. 8, depicted is a flow chart of an example method 800 that can facilitate generating a new online financial service, in accordance with various aspects and embodiments. The method 800 can be utilized at least in part, for example, by the financial services platform (e.g., by a financial services component, comprising the API component, of the financial services platform).

At 802, a financial service module associated with a first entity can be generated in connection with an online financial service. A first entity (e.g., third-party service developer, a financial service provider, a consumer, etc.) can utilize a communication device to access the API component, which can include a variety of APIs, API-related tools, and/or other functions that can be used to facilitate generating the financial service module. The financial service module can comprise one or more functions that can facilitate providing or performing an online financial service.

At 804, the financial service module can be associated with (e.g., combined with, integrated with, linked with, layered on top of, etc.) at least one online financial service and/or at least one financial service module associated with at least one other entity to facilitate generating a new online financial service. The first entity can use the communication device to access the API component, wherein the API component can facilitate associating the financial service module with at least one online financial service and/or at least one financial service module associated with at least one other entity (e.g., a different third-party service developer, financial service provider, or consumer, etc.) to facilitate generating a new online financial service. For example, the API component can be employed to facilitate associating the financial service module associated with the first entity with an online financial service or another financial service module associated with a second entity to facilitate generating a new online financial service comprising the financial service module and the online financial service or other financial service module. The financial service module can add or improve functionality (e.g., financial services-related functionality) to the online financial service or other financial service module with which it is associated. The new online financial service can be, for example, a new online financial service that can be based on multiple financial service modules or can be a modified online financial service (e.g., the at least one online financial service can be modified by associating the financial service module with it).

At 806, the new online financial service can be generated based at least in part on the associating of the financial service module with the at least one online financial service and/or the at least one financial service module. The API component can facilitate generating the new online financial service comprising the financial service module associated with the at least one online financial service and/or the at least one financial service module.

At 808, the new online financial service can be stored in a data store associated with a financial services store (e.g., associated with a financial services store component). The API component and/or the financial services store component can facilitate storing the new online financial service in the data store associated with the financial services store.

At 810, the new online financial service can be provided to a communication device associated with a user. A user (e.g., consumer, financial service provider, etc.) associated with the communication device can use the communication device to facilitate accessing the financial services store associated with the financial services platform. The financial services store can include the new online financial service. The financial services store component can facilitate providing (e.g., transmitting) the new online financial service to the communication device associated with the user. Depending on a defined financial services criterion(s), a preference(s) associated with the first entity, and/or a preference(s) associated with the at least one other entity, the financial services store component can facilitate providing the new online financial service to the communication device associated with the user at no cost or at a defined cost.

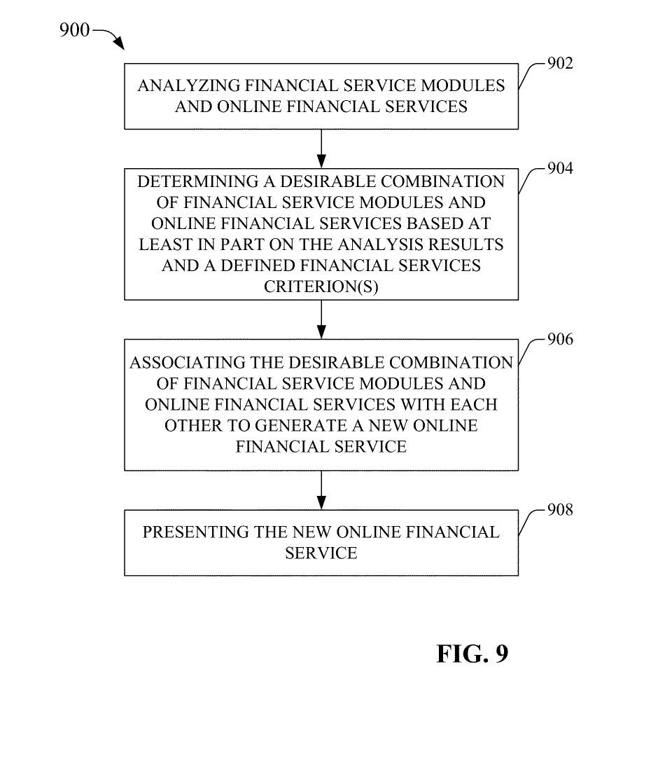

FIG. 9 presents a flow chart of an example method 900 for determining a desirable combination of financial service modules and/or online financial services to facilitate generating a new online financial service, in accordance with various aspects and embodiments of the disclosed subject matter. The method 900 can be utilized, for example, by the financial services platform (e.g., by the financial services component of the financial services platform).

At 902, financial service modules and online financial services can be analyzed. The financial services component can analyze financial service modules and online financial services associated with the financial services platform (e.g., stored in a data store and/or associated with the financial services store), and can generate analysis results based at least in part on the analysis, to facilitate determining or identifying a desirable (e.g., preferable, optimal, suitable, etc.) combination of financial service modules and online financial services for use in generating a new online financial service.

At 904, a desirable (e.g., preferred, suitable, compatible, beneficial, optimal, etc.) combination of financial service modules and online financial services can be determined (e.g., automatically determined) based at least in part on the analysis results and a defined financial services criterion(s). The financial services component can evaluate the analysis results and can determine the desirable combination of financial service modules and online financial services based at least in part on the analysis results and the defined financial services criterion(s). For example, the financial services component can evaluate the analysis results and can determine that associating (e.g., linking, combining, integrating, etc.) a financial service module with a first online financial service and a second online financial service can result in the creation of a new online financial service that can provide a financial service that can have a defined benefit or improvement over the respective financial services of the first online financial service and the second online financial service alone, and can determine that such combination of the first financial service module, the first online financial service, and the second online financial service can be desirable (e.g., preferable, optimal, suitable, etc.), in accordance with the defined financial services criterion(s).

At 906, the desirable combination of one or more financial service modules and one or more online financial services can be associated (e.g., linked, combined, integrated, etc.) with each other to generate a new online financial service. The financial services component can associate the desirable combination of financial service modules and online financial services with each other. For example, the financial services component can associate the financial service module with the first online financial service and the second online financial service, wherein the respective information (e.g., financial information) output components (e.g., output ports) of the first online financial service and the second online financial service can be interfaced with information (e.g., financial information) input components (e.g., input ports) of the financial service module. The financial service module can process the information received from the first online financial service and the second online financial service, based at least in part on the one or more functions (e.g., financial service functions) associated with the financial service module, to generate processed information (e.g., processed financial information) as an output (e.g., from one or more output ports of the financial service module).

At 908, the new online financial service can be presented and/or stored. The financial services component can store the new online financial service in a data store, can present or make available the new online financial service via the financial services store, or can provide (e.g., transmit) the new online financial service to a communication device associated with a user.

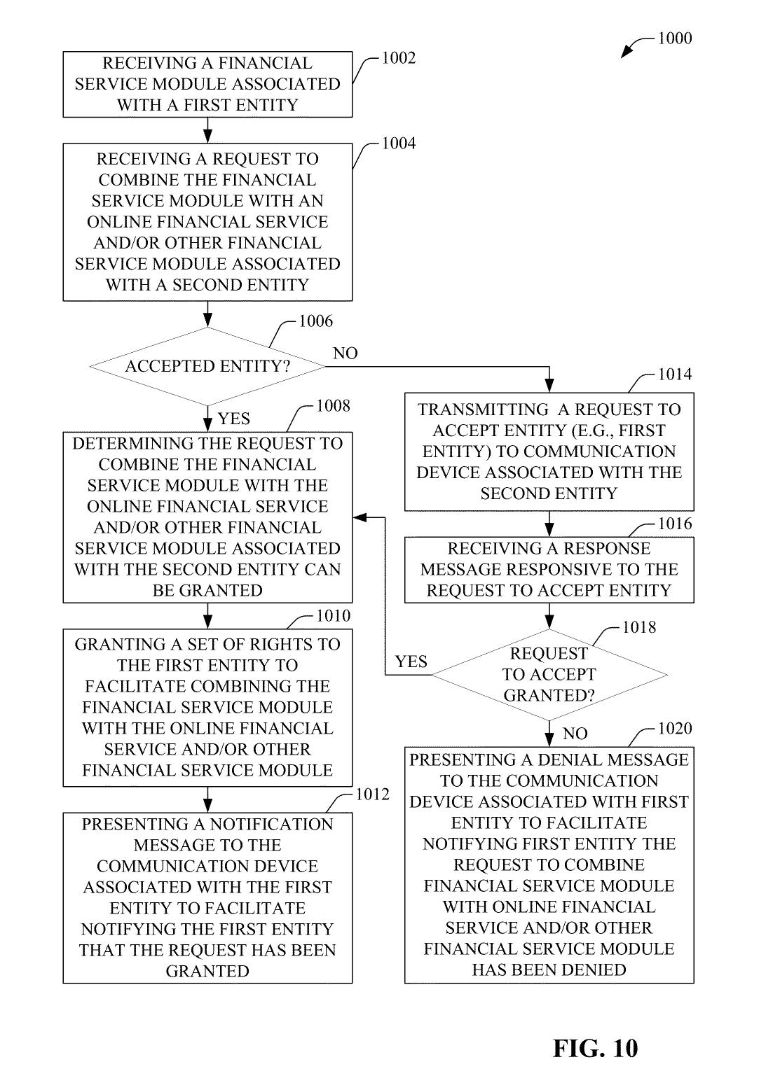

FIG. 10 illustrates a flow chart of an example method 1000 that can facilitate approving a first entity to combine a financial service module with a financial service module associated with a second entity to generate a new online financial service, in accordance with various aspects and embodiments. The method 1000 can be utilized, for example, by the financial services platform (e.g., by the financial services component of the financial services platform).

At 1002, a financial service module associated with a first entity (e.g., a third-party service developer) can be received, for example, by the financial services platform. The financial services component of the financial services platform can receive the financial service module from a communication device associated with the first entity. The first entity can use the communication device to send the financial service module to the financial services component in connection with seeking to generate a new online financial service comprising the financial service module and an online financial service and/or another financial service module associated with a second entity.

At 1004, a request to combine the financial service module with the online financial service and/or other financial service module associated with the second entity can be received, for example, by the financial services platform. The financial services component can receive the request from the communication device associated with the first entity.

At 1006, a determination can be made regarding whether the first entity is an accepted entity (e.g., a trusted or approved entity) in relation to the second entity. The financial services component can evaluate information in a first user profile associated with the first entity and/or information (e.g., trust-related or approval-related information) in a second user profile associated with the second entity to facilitate determining whether the first entity is an accepted entity in relation to the second entity. For example, the second user profile can include information that can indicate whether the first entity has previously been identified as a trusted or approved entity with respect to the second entity, and/or can indicate whether the first entity satisfies a defined financial services criterion(s) such that the first entity can be determined to be an accepted entity with respect to the second entity based at least in part on the information contained in the first user profile, the defined financial services criterion(s), user preferences (e.g., stored in the second user profile) associated with the second entity.

If it is determined that the first entity is an accepted entity with respect to the second entity, at 1008, it can be determined that the request to combine the financial service module with the online financial service and/or other financial service module associated with the second entity can be granted. In response to determining that the first entity is an accepted entity with respect to the second entity, the financial services component can determine that the request to combine the financial service module with the online financial service and/or other financial service module associated with the second entity can be granted.

At 1010, a set of rights can be granted to the first entity to facilitate allowing the first entity to use the communication device to facilitate combining the financial service module with the online financial service and/or other financial service module associated with the second entity. The financial services component can grant the set of rights to the first entity, wherein information relating to the set of rights can be stored in the first user profile, for example.

At 1012, a notification message can be presented (e.g., transmitted) to the communication device associated with the first entity to facilitate notifying the first entity that the request has been granted. The financial services component can generate the notification message and present the notification message to the communication device associated with the first entity. The first entity can use the communication device to facilitate combining the financial service module with the online financial service and/or other financial service module associated with the second entity to generate the new online financial service, in accordance with the set of rights. The financial services component can store the new online financial service in a data store, can present or make available the new online financial service via the financial services store, or can provide (e.g., transmit) the new online financial service to a communication device associated with a user.

Referring again to reference numeral 1006, if, at 1006, it is determined that the first entity is not yet an accepted entity with respect to the second entity, at 1014, a request to accept entity can be transmitted to the communication device associated with the second entity to facilitate requesting the second entity to accept the first entity in connection with the combining of the financial service module with the online financial service and/or other financial service module associated with the second entity to generate the new online financial service. The request to accept entity can comprise information relating to the first entity to enable the second entity to make an informed decision regarding whether to grant the request to accept the first entity.

At 1016, a response message responsive to the request to accept entity can be received. The financial services component can receive the response message from the communication device associated with the second entity. The response message can comprise information indicating whether the second entity accepts the first entity at least in connection with the combining of the financial service module with the online financial service and/or other financial service module associated with the second entity to generate the new online financial service.

At 1018, a determination can be made regarding whether the second entity granted the request to accept entity (e.g., to accept the first entity). The financial services component can evaluate the information in the response message and can determine whether the second entity granted the request to accept the first entity, based at least in part on the information contained in the response message.

If it is determined that the second entity granted the request to accept the first entity, the method 1000 can proceed to reference numeral 1008, wherein it can be determined that the request to combine the financial service module with the online financial service and/or other financial service module associated with the second entity can be granted, and the method 1000 can proceed from that point to perform the operations at 1010 and 1012.

If it is determined that the second entity did not grant the request to accept the first entity, at 1020, a denial message can be presented (e.g., transmitted) to the communication device associated with the first entity to facilitate notifying the first entity that the request to combine the financial service module with the online financial service and/or other financial service module associated with the second entity has been denied. The financial services component can generate the denial message and can present the denial message to the communication device associated with the first entity. The financial services component also can determine that the first entity is not to be granted any rights to combine the financial service module with the online financial service and/or other financial service module associated with the second entity.

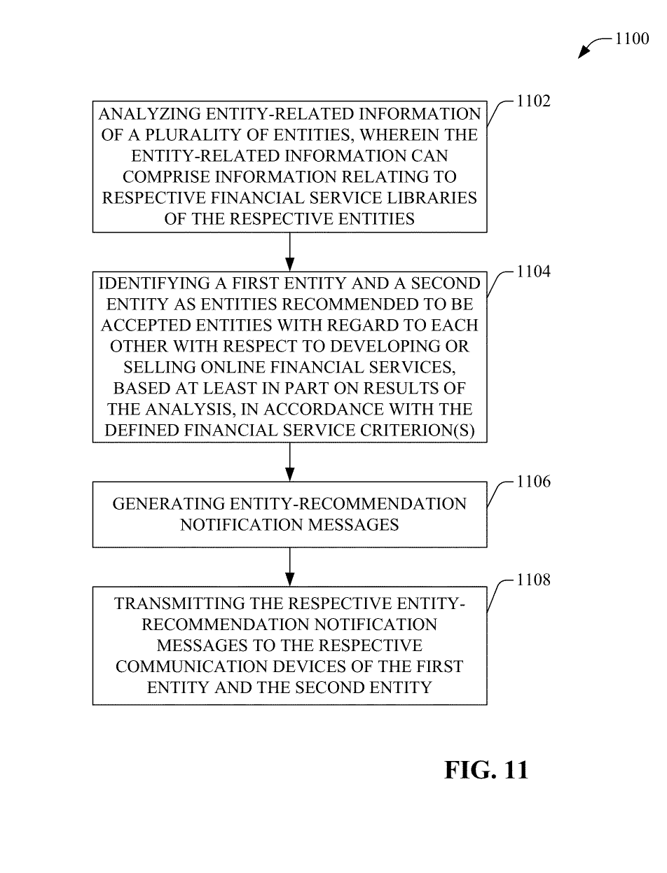

FIG. 11 depicts a flow chart of an example method 1100 that can facilitate identifying entities that can be recommended to be accepted entities (e.g., trusted entities) with regard to each other with respect to developing or selling online financial services, in accordance with various aspects and embodiments of the disclosed subject matter. The method 1100 can be utilized, for example, by the financial services platform (e.g., by the financial services component of the financial services platform).

At 1102, entity-related information of a plurality of entities (e.g., financial service providers, third-party service developers, etc.) can be analyzed, wherein the entity-related information can comprise information relating to respective financial service libraries of the respective entities. The financial services component can analyze the entity-related information, including the information relating to respective financial service libraries of the respective entities (e.g., as stored in the data store and/or financial services store), of the plurality of entities to facilitate identifying at least a first entity and a second entity that satisfy a defined financial service criterion(s) relating to matching entities with each other to facilitate partnering entities associated with the financial services platform to facilitate the development (e.g., generation) and/or sale of online financial services or financial service modules. A financial service library associated with an entity can comprise one or more online financial services or financial service modules that can be owned by, controlled by, or otherwise associated with the entity.

At 1104, a first entity and a second entity can be identified as entities recommended to be accepted entities with regard to each other with respect to developing or selling online financial services, based at least in part on the results of the analysis of the entity-related information, in accordance with the defined financial service criterion(s). The financial services component can determine or identify the first entity and the second entity as entities recommended to be accepted (e.g., trusted) entities with regard to each other with respect to developing or selling online financial services, based at least in part on the analysis results, in accordance with the defined financial service criterion(s).

For example, the financial services component can analyze the entity-related information and can determine that the first entity has online financial services and/or financial service modules that are related to online financial services and/or financial service modules of the second entity. For instance, the first entity has a online financial service that collects investment-related information associated with a consumer from a variety of sources (e.g., communication device(s) associated with an investment account(s), a mortgage lender(s), a savings account(s), etc., associated with the consumer), processes (e.g., coalesces, synthesizes, summarizes, etc.) the investment-related information, and presents the processed investment-related information to the communication device of the consumer for display on the communication device. The second entity has a financial service module that can analyze investment-related information and/or other information associated with a consumer, can generate an investment recommendation to facilitate improving the investment portfolio of the consumer based at least in part on the results of such analysis, and can present the investment recommendation to the communication device of the consumer for display on the communication device. The financial services component can determine that the first entity and the second entity can be matched to be recommended to be accepted entities with regard to each other because the online financial service of the first entity and the financial service module of the second entity satisfy a defined financial service criterion(s) relating to online financial services and financial service modules involving a same or similar type of financial service or function (e.g., involving consumer investments) and/or are otherwise compatible with each other (e.g., the processed investment-related information generated by the online financial service of the first entity can be used by the financial service module of the second entity to facilitate generating an investment recommendation for presentation to the consumer).

At 1106, entity-recommendation notification messages can be generated. The financial services component can generate entity-recommendation notification messages to facilitate notifying the first entity and the second entity that the financial services platform is recommending that the first entity and the second entity be accepted entities (e.g., partners) with each other with regard to at least the online financial service of the first entity and the financial service module of the second entity. The entity-recommendation notification message generated for the first entity can comprise a set of information relating to the second entity, including information relating to the financial service module, to facilitate informing the first entity about the second entity. The entity-recommendation notification message generated for the second entity can comprise a set of information relating to the first entity, including information relating to the online financial service, to facilitate informing the second entity about the first entity.

At 1108, the respective entity-recommendation notification messages can be transmitted to the respective communication devices of the first entity and the second entity. The financial services component can transmit the respective entity-recommendation notifications messages to the respective communication devices of the first entity and the second entity.

The respective communication devices can receive the respective entity-recommendation notification messages. The first entity can review the entity-recommendation notification message received by its communication device, and the first entity, or a UFSC associated with the communication device, can decide or determine whether the first entity is to be an accepted entity with respect to the second entity and, if so, determine the degree or level of acceptance or trust that is to be applied to the accepted entity relationship with the second entity. Similarly, the first entity can review the entity-recommendation notification message received by its communication device, and the second entity, or a UFSC associated with that communication device, can decide or determine whether the second entity is to be an accepted entity with respect to the first entity and, if so, determine the degree or level of acceptance or trust that is to be applied to the accepted entity relationship with the first entity.

There can be a variety of different degrees or levels of acceptance of trust. For example, a first level of acceptance can be that the first entity and the second entity can be accepted entities with respect to each other only in connection with the online financial service of the first entity and the financial service module of the second entity, wherein the online financial service and the financial service module can be combined to form a new online financial service that can be offered by the financial services store of the financial services platform. For instance, there can be a defined royalty or income sharing between the first entity and the second entity for each unit of the new online financial service sold via the financial services store. A second level of acceptance can be that the first entity and the second entity can be accepted entities with respect to each other with regard to their respective financial service libraries, wherein the first entity and the second entity (e.g., via their respective UFSCs and communication devices) agree to allow combinations of their respective online financial services and/or financial service modules in their respective libraries to generate new online financial services that can be offered by the financial services store of the financial services platform. For instance, there can be a defined royalty or income sharing between the first entity and the second entity for each unit of the one or more new online financial services sold via the financial services store. A third level of acceptance can be that, in addition to the entities agreeing to make their respective libraries of online financial services and/or finance service modules available to facilitate development of new online financial services, the first entity and the second entity can be accepted entities with respect to each other with regard to certain proprietary information associated with their respective financial service libraries, wherein the first entity and the second entity (e.g., via their respective UFSCs and communication devices) agree to allow each other to have access to the certain proprietary information of the other entity to facilitate generating new online financial services. For instance, the second entity can have access to certain proprietary information of the first entity with regard to an online financial service of the first entity to facilitate generating a new online financial service based at least in part on the certain proprietary information of the first entity and a new financial service module(s) developed by the second entity. The first entity and the second entity can agree to a defined royalty or income sharing between the first entity and the second entity for each unit of the one or more new online financial service sold via the financial services store.

The first entity and the second entity can respectively select the desired level of acceptance (e.g., first level, second level, third level, or other level), and can use their respective communication devices to communicate their respectively selected levels of acceptance to the financial services component. The financial services component can apply the respectively selected levels of acceptance, in accordance with a defined financial service criterion(s), wherein such criterion(s) can specify, e.g., that there is no agreed level of acceptance unless both entities agree to the same level of acceptance, the first entity and second entity can have different levels of acceptance in relation to each other, or the level of acceptance for the first and second entities is the lowest level of acceptance between the respective levels of acceptance selected by the first entity and second entity.

In some implementations, a legally binding contract can be required in connection with a level of acceptance agreed to between the first entity and the second entity. The financial services component can employ an online financial service for electronically signing contracts to create legally binding contracts such as more fully disclosed herein, for example, in relation to a contract that is electronically signed by a consumer in response to receiving a pre-approved financial offer. The contract between the first entity and the second entity can specify contract terms relating to the level of acceptance between the entities, the information that the entities agree to share with each other, the royalties or income sharing associated with sales of online financial services developed as a result of the cooperation of both the first and second entities, and/or other contract terms.

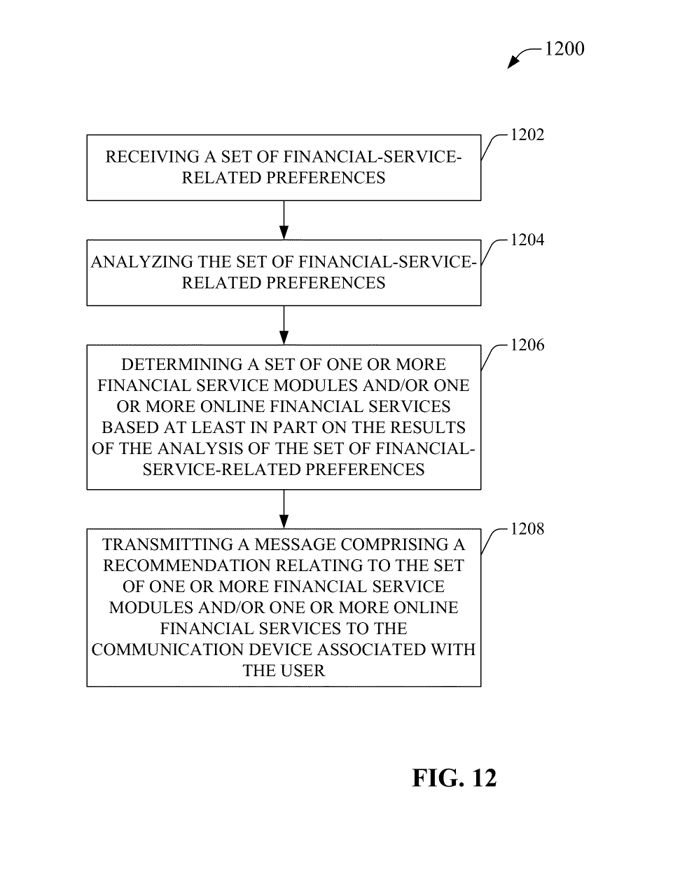

FIG. 12 illustrates a flow chart of an example method 1200 that can facilitate generating a recommendation(s) for a combination of financial service modules and online financial services (e.g., to form a customized online financial service) for a user, in accordance with various aspects and embodiments of the disclosed subject matter. The method 1200 can be utilized, for example, by the financial services platform (e.g., by the financial services component of the financial services platform).

At 1202, a set of financial-service-related preferences can be received. The financial services component can receive the set of financial-service-related preferences from a communication device associated with the user (e.g., consumer). For instance, the financial services component can present a menu or list of various financial-service-related options or features to the communication device associated with the user, wherein the user can use the communication device to facilitate selecting desired financial-service-related options or features to facilitate specifying or setting the set of financial-service-related preferences, and/or the financial services component can receive a free style listing (e.g., a search query) of various financial-service-related options or features from the communication device associated with the user to facilitate specifying or setting the set of financial-service-related preferences.

For example, the user can desire a feature that can collect or aggregate financial information from various different financial accounts (e.g., bank account(s), loan account(s), credit account(s), investment account(s), etc.) and income streams (e.g., employment income, investment income, etc.) of the user and can coalesce or synthesize the financial information of those financial accounts into a desired (e.g., a useful and/or an easy to understand or interpret) form to facilitate presenting the financial information by the communication device to the user. The user also can desire another feature that can analyze the financial situation or health of the user and render suggestions regarding how the user can improve the user's financial situation or health. The user also can desire still another feature that can send a notification to the communication device of the user when a defined threshold financial amount is satisfied (e.g., is met) with regard to a particular financial account (e.g., when the account balance in a checking account is below the defined threshold financial amount). The user can use the communication device to select or provide information regarding a set of financial-service-related preferences that can correspond to these desired features.

At 1204, the set of financial-service-related preferences can be analyzed. The financial services component can analyze the set of financial-service-related preferences to facilitate determining or identifying one or more financial service modules and/or one or more online financial services that, e.g., when combined, can provide the user with all of the desired financial-related features associated with the set of financial-service-related preferences. For example, the financial services component can search the financial services store and/or data store and can analyze or evaluate (e.g., compare) the set of financial-service-related preferences in relation to the respective features of the respective financial service modules and online financial services in the financial services store and/or data store to facilitate determining the one or more financial service modules and/or one or more online financial services that can provide the user with all of the desired financial-related features associated with the set of financial-service-related preferences.

At 1206, a set of one or more financial service modules and/or one or more online financial services can be determined based at least in part on the results of the analysis of the set of financial-service-related preferences. The financial services component can determine or identify the set of one or more financial service modules and/or one or more online financial services based at least in part on the analysis results. The financial services component also can determine or identify how the respective financial service modules and/or respective online financial services are to be associated with each other (e.g. combined, integrated, and/or linked, etc., with each other) to operate properly with each other to facilitate providing the desired features or financial services to the user. The set of one or more financial service modules and/or one or more online financial services can be associated with each other to form a new, customized online financial service for the user.

At 1208, a message comprising a recommendation relating to the set of one or more financial service modules and/or one or more online financial services can be transmitted to the communication device associated with the user. The financial services component can generate the message comprising the recommendation and can send it to the communication device. The recommendation can suggest that the user use or purchase the set of one or more financial service modules and/or one or more online financial services (e.g., associated with each other to form the customized online financial service) from the financial services store, wherein the set of one or more financial service modules and/or one or more online financial services can facilitate providing the financial-related features desired by the user as indicated in the set of financial-service-related preferences.

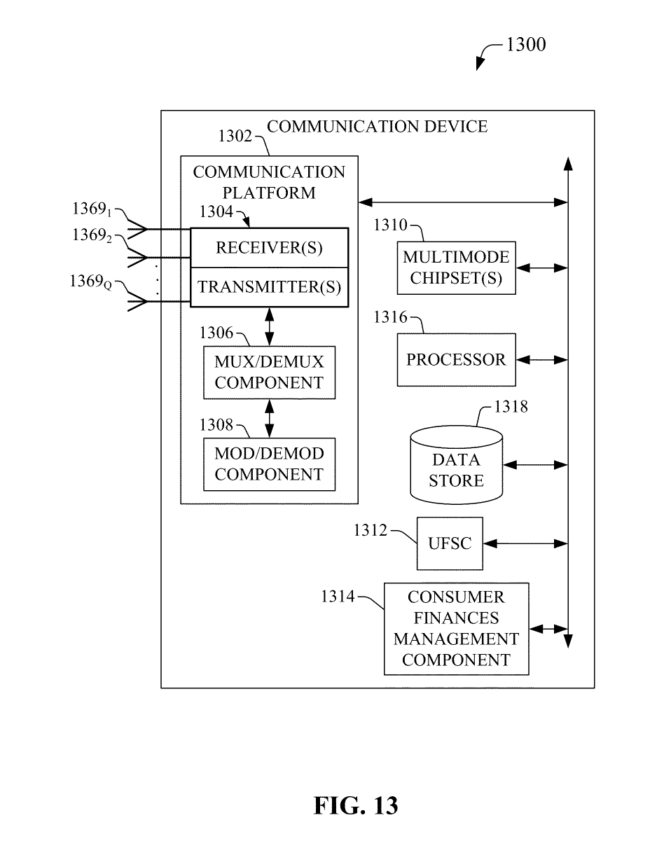

FIG. 13 depicts a block diagram of an example wireless communication device 1300 in accordance with various aspects and embodiments of the disclosed subject matter. The communication device 1300 can be a multimode access terminal, wherein a set of antennas 1369₁-1369_{Q} (Q is a positive integer) can receive and transmit signal(s) from and to wireless devices like access points, access terminals, wireless ports and routers, and so forth, that operate in a radio access network. It should be appreciated that antennas 1369₁-1369_{Q} are a part of communication platform 1302, which comprises electronic components and associated circuitry that provide for processing and manipulation of received signal(s) and signal(s) to be transmitted; e.g., receivers and transmitters 1304, multiplexer/demultiplexer (mux/demux) component 1306, and modulation/demodulation (mod/demod) component 1308.

The communication device 1300 can include a multimode operation chipset(s) 1310 that can allow the communication device 1300 to operate in multiple communication modes in accordance with disparate technical specification for wireless technologies. The multimode operation chipset(s) 1310 can utilize communication platform 1302 in accordance with a specific mode of operation (e.g., voice, GPS). The multimode operation chipset(s) 1310 can be scheduled to operate concurrently (e.g., when Q>1) in various modes or within a multitask paradigm.

The communication device 1300 can comprise a UFSC 1312 that can facilitate managing and using online financial services associated with the user (e.g., consumer) of the communication device 1300, as more fully disclosed herein. The UFSC 1312 can be installed on the communication device 1300 by installing an application comprising the UFSC functionality, for example. The communication device 1300 also can comprise a consumer finances management component 1314 that can be used to facilitate receiving, reviewing, and/or accepting offers (e.g., approved financial offers) from the open credit exchange program, execute electronic contract documents relating to an approved financial offer, manage a digital wallet and/or finances (e.g., pay debts, transfer monetary funds between accounts, etc.) associated with a consumer, etc., as more fully described herein. The consumer finances management component 1314 can be installed on the communication device 1300 by installing an application comprising the functionality of the consumer finances management component 1314, for example.

In still another aspect, the communication device 1300 also can include a processor(s) 1316 that can be configured to confer functionality, at least in part, to substantially any electronic component within the communication device 1300, in accordance with aspects of the disclosed subject matter. For example, the processor(s) 1316 can facilitate enabling the communication device 1300 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 1316 can facilitate enabling the communication device 1300 to process data relating to managing and using online financial services, managing a digital wallet associated with the consumer, managing finances associated with the consumer, approved financial offers, executing electronic contract documents relating to an approved financial offer, authentication of the consumer or another entity, securing data (e.g., cryptographically securing data) and/or other data processes relating to processing information, including processing financial-related information.

The communication device 1300 also can contain a data store 1318 that can store data structures (e.g., user data, metadata); code structure(s) (e.g., modules, objects, classes, procedures) or instructions; message hashes; information relating to managing and using online financial services, managing a digital wallet associated with the consumer, managing finances associated with the consumer, approved financial offers, executing electronic contract documents relating to an approved financial offer, authentication of the consumer or another entity, securing data, etc.; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 1316 can be functionally coupled (e.g., through a memory bus) to the data store 1318 in order to store and retrieve information (e.g., information relating to mobile messaging, voice calls, or other services; frequency offsets; desired algorithms; information relating to managing a digital wallet associated with the consumer, managing finances associated with the consumer, approved financial offers, executing electronic contract documents relating to an approved financial offer, authentication of the consumer or another entity, or securing data; etc.) desired to operate and/or confer functionality, at least in part, to the communication platform 1302, multimode operation chipset(s) 1310, UFSC 1312, consumer finances management component 1314, and/or substantially any other operational aspects of the communication device 1300.

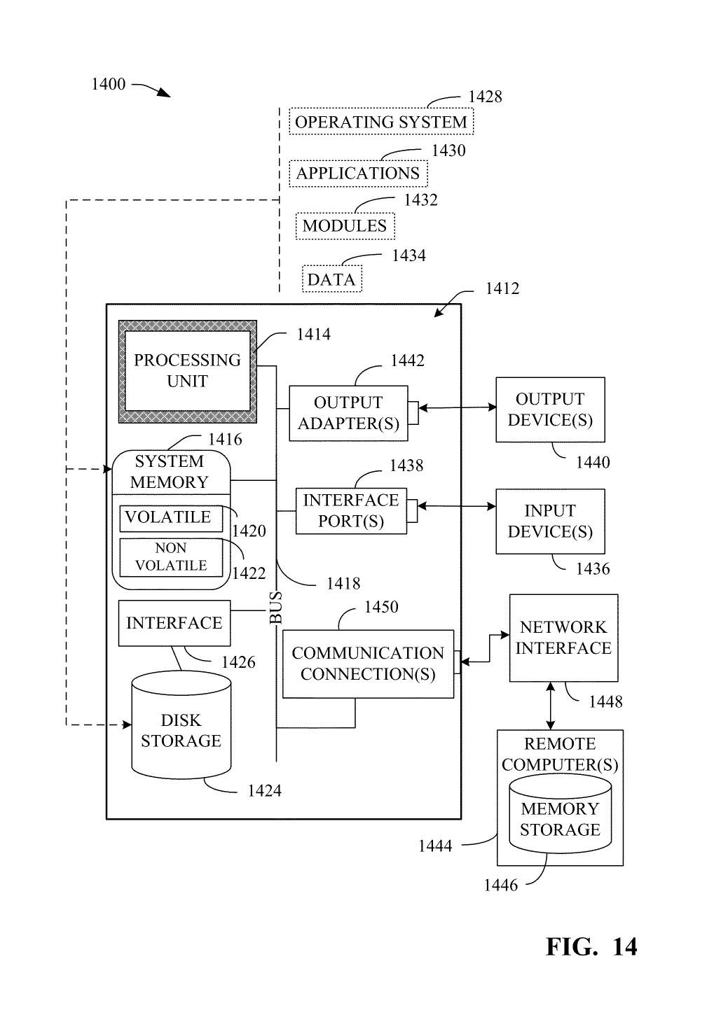

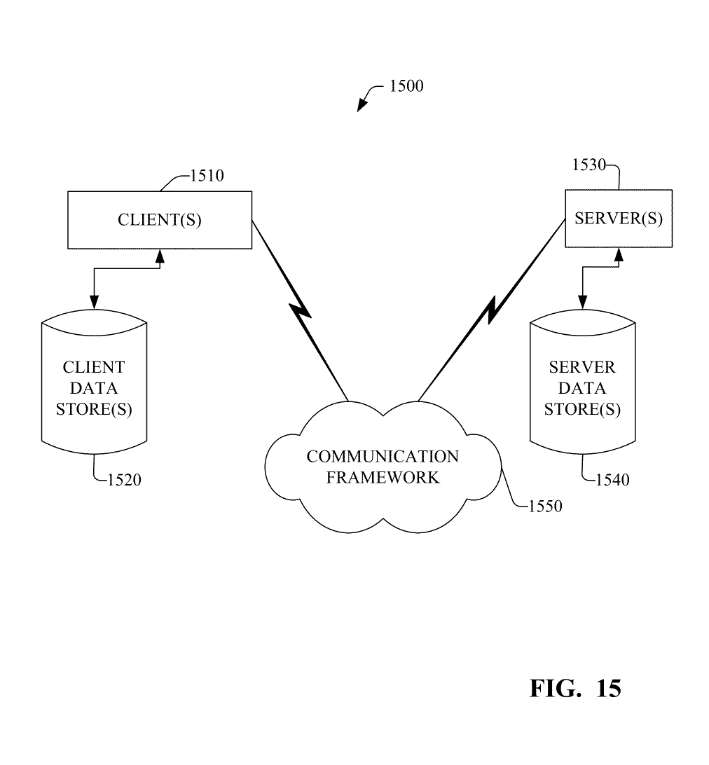

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

In accordance with various aspects and embodiments, the computer (e.g., 1412) can be, for example, a communication device that can include or can be associated with a financial services platform and can comprise, be associated with, and/or implement various aspects and/or functions of the financial services platform; a communication device that can be associated with a financial service provider and can comprise, be associated with, and/or implement various aspects and/or functions of a UFSC and/or an FSP credit management component; a communication device that can be associated with a third-party developer and can comprise, be associated with, and/or implement various aspects and/or functions of a UFSC; or a communication device that can be associated with a consumer and can comprise, be associated with, and/or implement various aspects and/or functions of a UFSC and/or a consumer finances management component.

With reference to FIG. 14, a suitable environment 1400 for implementing various aspects of the disclosed subject matter includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), or flash memory. Volatile memory 1420 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 also includes removable/non-removable, volatile/non-volatile computer storage media. FIG. 14 illustrates, for example, a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used, such as interface 1426.

It is to be appreciated that FIG. 14 describes software that acts as an intermediary between users and the basic computer resources described in the suitable operating environment 1400. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the claimed subject matter can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

FIG. 15 is a schematic block diagram of a sample-computing environment 1500 with which the subject specification can interact. The system 1500 includes one or more client(s) 1510. The client(s) 1510 can be hardware and/or software (e.g., threads, processes, computing devices). The system 1500 also includes one or more server(s) 1530. Thus, system 1500 can correspond to a two-tier client server model or a multi-tier model (e.g., client, middle tier server, data server), amongst other models. The server(s) 1530 can also be hardware and/or software (e.g., threads, processes, computing devices). The servers 1530 can house threads to perform transformations by employing the disclosed subject matter, for example. One possible communication between a client 1510 and a server 1530 may be in the form of a data packet transmitted between two or more computer processes.

The system 1500 includes a communication framework 1550 that can be employed to facilitate communications between the client(s) 1510 and the server(s) 1530. The client(s) 1510 are operatively connected to one or more client data store(s) 1520 that can be employed to store information local to the client(s) 1510. Similarly, the server(s) 1530 are operatively connected to one or more server data store(s) 1540 that can be employed to store information local to the servers 1530.

It is to be appreciated and understood that components (e.g., financial services platform, financial services component, API component, financial services store component, search engine, UFSC, open credit exchange platform, credit management component, communication device, FSP credit management component, consumer finances management component, communication network, etc.), as described with regard to a particular system or method, can include the same or similar functionality as respective components (e.g., respectively named components or similarly named components) as described with regard to other systems or methods disclosed herein.

As used in this application, the terms “component,” “system,” “platform,” “module,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “communication device,” “wireless communication device,” and similar terminology can refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “consumer,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be noted that aspects, features, and/or advantages of the disclosed subject matter can be exploited in substantially any wireless telecommunication or radio technology, e.g., WI-FI; Bluetooth; Worldwide Interoperability for Microwave Access (WIMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and flash memory devices (e.g., card, stick, key drive, etc.), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory to store computer-executable components; and
a processor, coupled to the memory, that executes or facilitates execution of at least one of the computer-executable components, the computer-executable components comprising:
a financial services component that facilitates generation of a set of online financial services that comprises a first online financial service associated with a first service identity and a second online financial service associated with a second service identity; and
a financial services management component that facilitates controlling use of the set of online financial services by communication devices associated with consumer identities of a set of consumer identities.

2. The system of claim 1, further comprising an application programming interface (API) component that comprises a set of API sub-components that facilitate the generation of the set of online financial services.

3. The system of claim 2, wherein the API component facilitates enabling the generation of the first online financial service using a first communication device associated with the first service identity and the generation of the second online financial service using a second communication device associated with the second service identity.

4. The system of claim 3, wherein the first online financial service comprises a first financial service module and a second financial service module, the first financial service module facilitates performing a first financial service operation on financial-related information associated with a consumer identity, and the second financial service module facilitates performing a second financial service operation on the financial-related information associated with the consumer identity.

5. The system of claim 4, wherein the API component facilitates generation of a third financial service module via use of the set of API sub-components by a third communication device associated with a third service identity.

6. The system of claim 5, wherein the API component facilitates the generation of a third online financial service via use of the set of API sub-components by a third communication device associated with a third service identity, wherein the third online financial service comprises the first financial service module associated with the first service identity, the second financial service module associated with the first service identity, and the third financial service module associated with the third service identity.

7. The system of claim 1, further comprising:
an open credit exchange component that is associated with a set of financial service provider identities and the set of consumer identities, and facilitates presentation of a preferred approved financial offer to a communication device determined to be associated with a consumer identity of the set of consumer identities; and
a credit management component that determines the preferred approved financial offer, based at least in part on an analysis of a set of approved financial offers received from one or more financial service provider identities of the set of financial service provider identities and a defined financial offer criterion with respect to a pre-computed financial health score associated with the consumer identity, to facilitate the presentation of the preferred approved financial offer to the communication device associated with the consumer identity.

8. The system of claim 7, wherein the first online financial service relates to identity management associated with the consumer identity, and the credit management component facilitates use of the first online financial service by the communication device associated with the consumer identity to facilitate controlling an amount or a type of financial-related information associated with the consumer identity that is exposed to the set of financial service provider identities based at least in part on a set of preferences associated with the consumer identity.

9. The system of claim 7, wherein the first online financial service relates to facilitating application of a digital signature to an electronic contract document associated with the preferred approved financial offer and verification of the digital signature, and the credit management component facilitates use of the first online financial service by the communication device associated with the consumer identity to facilitate the application of the digital signature to the electronic contract document via the communication device associated with the consumer identity, and facilitates the verification of the digital signature on the electronic contract document by the credit management component.

10. The system of claim 1, wherein the set of online financial services comprises a first subset of online financial services and a second subset of online financial services, the financial services component facilitates access of the first subset of online financial services by a communication device associated with a consumer identity of the set of consumer identities, and the financial services management component facilitates enabling the communication device to be used to control switching of an online financial service of the second subset of online financial services between an active state and an inactive state in connection with the consumer identity.

11. The system of claim 10, wherein the first subset of online financial services comprises at least one of a deposit financial service that facilitates an electronic deposit of monetary funds to a financial account, a transfer financial service that facilitates an electronic transfer of monetary funds between financial accounts, or a payment financial service that facilitates scheduling an electronic payment to a financial account; and the second subset of online financial services comprises at least one of an identity-management financial service that facilitates controlling an amount or a type of financial-related information associated with the consumer identity that is exposed to a set of financial service provider identities associated with the financial services component based at least in part on a set of preferences associated with the consumer identity, or a signature financial service that facilitates application of a digital signature to an electronic contract document.

12. The system of claim 1, wherein the financial services component analyzes a first set of online financial services or financial service modules associated with the first service identity and a second set of online financial services or financial service modules associated with the second service identity, and determines whether to recommend to the first service identity and the second service identity that they be accepted service entities with each other with regard to combining of at least a portion of the first set and a portion of the second set, in accordance with a defined financial services criterion.

13. The system of claim 12, wherein, in response to determining recommending the first service identity and the second service identity be accepted service entities with each other, the financial services component generates a recommendation message and transmits the recommendation to a first communication device associated with the first service identity and a second communication device associated with the second service identity.

14. A method, comprising:
facilitating, by a system comprising a processor, generation of a set of online financial services that comprises a first online financial service associated with a first service identity and a second online financial service associated with a second service identity; and
controlling, by the system, use of the set of online financial services by communication devices associated with consumer identities of a set of consumer identities.

15. The method of claim 14, further comprising:
generating, by the system, a plurality of application programming interface (API) sub-components that facilitate the generation of the set of online financial services;
facilitating, by the system, the generation of the first online financial service using a first portion of the API sub-components by a first communication device associated with the first service identity; and
facilitating, by the system, the generation of the second online financial service using a second portion of the API sub-components by a second communication device associated with the second service identity.

16. The method of claim 15, further comprising:
facilitating, by the system, generation of a first financial service module and a second financial service module to facilitate generation of the first online financial service associated with the first service identity.

17. The method of claim 16, further comprising:
facilitating, by the system, generation of a third financial service module via use of a third portion of the set of API sub-components by a third communication device associated with a third service identity; and
facilitating, by the system, the generation of a third online financial service via use of the third portion of the set of API sub-components by the third communication device, wherein the third online financial service comprises the first financial service module associated with the first service identity, the second financial service module associated with the first service identity, and the third financial service module associated with the third service identity.

18. The method of claim 14, further comprising:
analyzing, by the system, a set of approved financial offers received from one or more financial service provider identities in relation to a consumer identity of the set of consumer identities; and
determining, by the system, a highest-rated approved financial offer from the set of approved financial offers, based at least in part on results of the analyzing of the set of approved financial offers and a financial offer criterion defined as a function of a determined financial health score associated with the consumer identity, to facilitate presenting the highest-rated approved financial offer to a communication device associated with the consumer identity.

19. The method of claim 18, wherein the first online financial service relates to identity management associated with the consumer identity, the method further comprises:
facilitating, by the system, use of the first online financial service by the communication device associated with the consumer identity to facilitate controlling an amount or a type of financial-related information associated with the consumer identity that is exposed to the set of financial service provider identities based at least in part on a set of preferences associated with the consumer identity.

20. The method of claim 18, wherein the first online financial service relates to application of a digital signature to an electronic contract document associated with the preferred approved financial offer and verification of the digital signature, the method further comprises:
facilitating, by the system, use of the first online financial service by the communication device associated with the consumer identity to facilitate the application of the digital signature to the electronic contract document via the communication device associated with the consumer identity; and
facilitating, by the system, the verification of the digital signature on the electronic contract document by the credit management component.

21. The method of claim 14, wherein the set of online financial services comprises a first subset of online financial services and a second subset of online financial services, the method further comprises:
facilitating, by the system, access of the first subset of online financial services by a communication device associated with a consumer identity of the set of consumer identities; and
facilitating, by the system, controlling switching of an online financial service of the second subset of online financial services between an active state and an inactive state by the communication device associated with the consumer identity.

22. The method of claim 14, further comprising:
analyzing, by the system, a first set of online financial services or financial service modules associated with the first service identity and a second set of online financial services or financial service modules associated with the second service identity; and
determining, by the system, whether to recommend to the first service identity and the second service identity that they be accepted service entities with each other with regard to combining of at least a portion of the first set and a portion of the second set, in accordance with a defined financial services criterion.

23. The method of claim 22, further comprising:
in response to determining recommending the first service identity and the second service identity be accepted service entities with each other, generating, by the system, a recommendation message that recommends that the first service identity and the second service identity be accepted service entities with each other; and
transmitting the recommendation to a first communication device associated with the first service identity and a second communication device associated with the second service identity.

24. A tangible computer-readable medium storing computer-executable instructions that, in response to execution, cause a system comprising a processor to perform operations, comprising:
facilitating generation of a set of online financial services that comprises a first online financial service associated with a first service identity and a second online financial service associated with a second service identity; and
controlling use of the set of online financial services by communication devices associated with consumer identities of a set of consumer identities.

25. The tangible computer-readable medium of claim 24, wherein the operations further comprise:
evaluating a set of approved financial offers received from one or more financial service provider identities in relation to a consumer identity of the set of consumer identities; and
determining a preferred approved financial offer from the set of approved financial offers, based at least in part on results of the evaluating of the set of approved financial offers and a financial offer criterion defined as a function of a defined financial health score associated with the consumer identity, to facilitate presenting the preferred approved financial offer to a communication device associated with the consumer identity, wherein the preferred approved financial offer has a highest financial offer score relative to financial offer scores of other approved financial offers in the set of approved financial offers, and the defined financial health score is a financial health score that is updated by the system in an always-on operating environment.
